(19) United States
(12) Patent Application Publication
(10) Pub. No.: US 2018/0030759 A1
(43) Pub. Date: Feb. 1, 2018

(54) Electronic Gate Latch

(71) Applicant: James Chanbonpin, Henderson, NV (US)

(72) Inventor: James Chanbonpin, Henderson, NV (US)

(21) Appl. No.: 15/657,346

(22) Filed: Jul. 24, 2017

Related U.S. Application Data
(60) Provisional application No. 62/366,637, filed on Jul. 26, 2016.

(51) Int. Cl. E05B 47/00; E05B 65/00; E05B 17/00; G07C 9/00

(52) U.S. Cl. CPC E05B 47/0001; G07C 9/00309; E05B 65/0007; E05B 17/0029; E05Y 2900/40

(57) ABSTRACT

A device for locking a gate includes a body, a pawl, a motor, and a computing device. The body includes an opening configured to receive a latch bar. The pawl has a locked state and an unlocked state. The pawl is disposed in the opening of the body and is pivotally connected to the body. The motor is configured to actuate the pawl between the locked state and the unlocked state. The computing device is configured to control the motor.

### CROSS-REFERENCE TO RELATED APPLICATIONS

This application claims priority to U.S. Provisional Patent Application No. 62/366,637, entitled “Electronic Latch Release,” filed on 26 Jul. 2016, the entire disclosure of which is hereby incorporated herein by reference.

### TECHNICAL FIELD

The present disclosure generally relates to fasteners for gates, doors, or other movable barriers; and more specifically, to a device, system, and method for electronically locking and unlocking a gate, door, or other movable barrier.

### BACKGROUND

Personal residences, commercial real estate, and other properties commonly have security fences, walls, or other perimeter barriers. These fences generally have gates, doors, or otherwise movable barriers which provision access to secured areas. Such gates may be conventionally secured in a closed position by a mechanical gate latch apparatus, which may or may not have the ability to lock.

Where conventional gate latches can lock, the gate latch may include a manually-actuated locking system, or the gate latch may be secured by manually engaging, e.g., a padlock through holes formed in a latching portion of the gate latch. Both methods generally employ manual actuation to lock and unlock the gate latch.

### SUMMARY

General aspects of the disclosure herein describe an electronic gate lock device. The electronic gate lock device includes a body having an opening configured to accept a latch bar. The electronic gate lock device also includes a pawl having a locked state and an unlocked state. The pawl is disposed in the opening and pivotally connected to the body. The electronic gate lock device also includes a motor configured to switch, change, or otherwise adjust the pawl between the locked state and the unlocked state. The gate lock device includes a computing device configured to control the motor.

Representative implementations of the electronic gate lock device may include the pawl being configured to allow or otherwise permit the latch bar to enter the opening in the unlocked state or the locked state, allow or otherwise permit the latch bar to exit the opening in the unlocked state, and trap or otherwise retain the latch bar in the opening in the locked state. The electronic gate lock device includes a wireless communication device configured to provide wireless communication between the computing device and an external input device. The wireless communication device is configured to wirelessly communicate by one or more of Bluetooth, near-field communication (NFC), WiFi, radio-frequency identification (RFID), radio-frequency (RF), infrared radiation (IR), Z-Wave, ZigBee, 6LoWPAN, Thread, Long-Term Evolution (LTE), or other wireless communication protocol. The external input device may be at least one of a cell phone, a tablet, a computer, a key fob, a router, a radio-frequency identification (RFID) card, an RFID token, an external authentication device or a remote. The electronic gate lock device may further include a wired communication port configured to provide wired communication between the computing device and an input device. The input device may be at least one of a weather-monitoring device, a cell phone, a tablet, a computer, a keypad, an external authentication device, or a biometric authentication device. The body of the electronic gate lock device may be configured to be weather resistant, shock resistant, and tamper-proof. The electronic gate lock device may further include at least one of a weather monitoring device, a speaker, a microphone, or a camera disposed within the body. The electronic gate lock device further includes a power source configured to provide power to the motor and the computing device. The power source includes at least one of a battery (e.g., internal, or external), a wired power source, or a power generation device. The electronic gate lock device may further include a panic button, e.g., disposed on an outside surface of the body. The panic button may be configured to place the computing device in an alarmed state. In the alarmed state, the computing device may be configured to activate a speaker to sound an alarm, and controls the motor to dispose the pawl in the locked state. The electronic gate lock device may further include a manual actuator configured to override computing-device control of the motor.

A general aspect includes a system for locking a movable barrier in a closed position relative to an enclosure. The system includes a latch bar attached to a movable barrier and a device attached to an enclosure. The movable barrier is rotatable between an open position and a closed position relative to the enclosure. The device includes a body having an opening configured to receive and retain the latch bar. The device further includes a pawl having a locked state and an unlocked state. The pawl is disposed in the opening and pivotally connected to the body. The pawl is configured to allow the latch bar to enter the opening in the unlocked state or the locked state, fasten the latch bar in the opening in the locked state, and allow the latch bar to exit the opening in the unlocked state. The device also includes a motor configured to switch the pawl between the locked state and the unlocked state. The device includes a computing device disposed within the body. The computing device is configured to control the motor.

The latch bar may be configured to be removable from the movable barrier, and the device may be configured to be substantially removable from the enclosure when the pawl is in the unlocked state. The latch bar may be configured to be substantially irremovable from, or substantially affixed to, the movable barrier. The device may be configured to be substantially irremovable from, or substantially affixed to, the enclosure when the pawl is in the locked state. The latch bar may be attached to the movable barrier through a latch bar mounting plate, and the device may be attached to the enclosure through a device mounting plate. The device may replace an existing gate latch apparatus. The latch bar may be a latch bar that was previously installed on the movable barrier or may be part of the movable barrier itself. The pawl may be configured to pivot between an extended position and a retracted position in the unlocked state, pivot between the extended position and the retracted position when the movable barrier is rotated from the open position to the closed position in the locked state, and remain fixed in the extended position in the locked state when the movable barrier is in the closed position. The device may further include a detector configured to detect disposition of the latch bar in the opening, and to communicate with the computing device. The device may further include an internal locking device that is configured to substantially irremovably affix the device to a device mounting plate when the internal lock is in a fastened state.

A method for mounting an electronic gate lock device includes steps of disposing a latch bar on a movable barrier, and disposing a device on an enclosure. The device includes a body having an opening configured to accept and retain the latch bar. The device further includes a pawl having a locked state and an unlocked state. The pawl may be disposed in the opening and pivotally connected to the body. The pawl is configured to allow or otherwise permit the latch bar to enter the opening in the unlocked state or the locked state, secure the latch bar in the opening in the locked state, and allow or otherwise permit the latch bar to exit the opening in the unlocked state. The device further includes a motor that is configured to transition the pawl between the locked state and the unlocked state. The device includes a computing device disposed within the body of the gate lock device. The computing device is configured to control the motor.

### BRIEF DESCRIPTION OF THE DRAWINGS

Representative aspects of the present disclosure may be understood from the following detailed description when read in conjunction with the accompanying Figures. It is noted that, in accordance with standard practice in industry, various features may not be drawn to scale. For example, dimensions of various features may be arbitrarily increased or reduced for clarity of illustration or description. Corresponding numerals and symbols in different Figures generally refer to corresponding parts, unless otherwise indicated.

FIG. 1 representatively illustrates a front elevation view of a device attached to an enclosure and a latch bar attached to a movable barrier in accordance with an embodiment.

FIG. 2 representatively illustrates a front elevation view of a device mounting plate attached to an enclosure and a latch bar mounting plate attached to a movable barrier in accordance with an embodiment.

FIGS. 3A through 3D representatively illustrate front elevation views of device structures corresponding to a method of attaching a device to a device mounting plate in accordance with an embodiment.

FIG. 4 representatively illustrates a front elevation view of a device attached to a device mounting plate in accordance with an embodiment.

FIGS. 5A and 5B representatively illustrate a side elevation view and a front elevation view, respectively, of a device having a camera disposed adjacent to an opening in accordance with an embodiment.

FIGS. 6A and 6B representatively illustrate a front elevation view and a side elevation view, respectively, of a device having a keypad disposed on a side surface in accordance with an embodiment.

FIG. 7 representatively illustrates a front elevation view of a device having a manual actuator in accordance with an embodiment.

FIG. 8 representatively illustrates a perspective view of a device in accordance with an embodiment.

FIG. 9 representatively illustrates a perspective view of a latch bar disposed within an opening of a device in accordance with an embodiment.

FIGS. 10A and 10B representatively illustrate perspective views of a device having a pawl in an extended position and a retracted position, respectively, in accordance with an embodiment.

FIG. 11 representatively illustrates a front elevation view of a latch bar disposed in an opening of a device in accordance with an embodiment.

FIG. 12 representatively illustrates a cross-sectional view of a device in accordance with an embodiment.

FIG. 13 representatively illustrates a perspective view of a device that includes a wired communication port connected to an external input device in accordance with an embodiment.

FIG. 14 representatively illustrates a side elevation view of a device in wireless communication with various external input devices in accordance with an embodiment.

FIG. 15 representatively illustrates a front elevation view of a device in wireless communication with various external input devices in accordance with an embodiment.

FIG. 16 representatively illustrates a side elevation view of a device that includes a panic button in accordance with an embodiment.

FIG. 17 representatively illustrates a front elevation view of an external authentication device in accordance with an embodiment.

FIG. 18 representatively illustrates a front elevation view of a system for locking a movable barrier in a closed position relative to an enclosure in accordance with an embodiment.

FIGS. 19A through 19C representatively illustrate front elevation views corresponding to a method of removing a conventional gate latch apparatus from and attaching a device to an enclosure in accordance with an embodiment.

FIG. 20 representatively illustrates a perspective view of a device attached to an enclosure in accordance with an embodiment.

FIG. 21 representatively illustrates a perspective view of a device attached to an enclosure and a latch bar attached to a movable barrier in accordance with an embodiment.

FIG. 22 representatively illustrates a front elevation view of a latch bar disposed within an opening in a device in accordance with an embodiment.

FIG. 23 representatively illustrates a method in accordance with an embodiment.

FIG. 24 representatively illustrates a method in accordance with an embodiment.

FIG. 25 representatively illustrates a method in accordance with an embodiment.

FIG. 26 representatively illustrates a cellphone displaying weather data in accordance with an embodiment.

### DETAILED DESCRIPTION

Representative embodiments are discussed in detail below; however, it should be appreciated that concepts disclosed herein may be embodied in a variety of contexts, and that specific embodiments discussed herein are merely illustrative and are not intended to limit the scope of the claims. Furthermore, various changes, substitutions, or alterations can be made herein without departing from the spirit and scope of the appended claims.

Many conventional gate latch apparatuses either cannot be locked, or generally require manual actuation for locking/unlocking. Conventional manual gate latch apparatuses typically include a hole through which a padlock or similar locking device may be passed through in order to secure and lock the gate latch apparatus. These gate latch apparatuses must be manually unlocked and locked each time the gate is used. Accordingly, conventional gate latch apparatuses have several disadvantages. For example: keys can be misplaced, lost, or forgotten; keys can easily be duplicated; gate latches cannot be opened remotely or without a key; and “hide-a-key” implementations are generally not secure. Conventional gate latch apparatuses and locking devices used on these gate latch apparatuses cannot give the status of the latch to a user, allow a user to control whether the gate latch apparatus is locked or unlocked from another geographical location, detect whether the gate is open or closed, or allow entry for specific date or times or allow a discrete number of ingress/egress transits for specific visitors. In many cases, a property owner may want to allow people to access their property without giving those people access to a key. For example, a property owner may wish to allow a landscaper access to a secured area on their property in order to mow the lawn, or the property owner may wish to allow a delivery person to deliver a parcel in a secured area on their property, without the property owner needing to be present. Moreover, a property owner may lose or misplace their keys, and therefore not be able to access a secured area of their property. Accordingly, there is a need for a device which allows a property owner to control access to a secured external area of their property without the need for keys. An electronic gate lock device according to representative embodiments may replace a conventional gate latch apparatus and may provide additional automation, accessibility, security features, or the like.

According to representative aspects, an enclosure, such as a fence or a wall, may be used to restrict access to a secured external area of a property. For example, an enclosure may surround a perimeter of a property, or an enclosure may be attached to a house, a building, or other structure. The enclosure and the house together may surround the perimeter of the property. In some embodiments, the enclosure may be provided with a movable barrier, e.g., a gate or door, to allow people to enter or exit a secured area of the property.

According to various embodiments, an electronic gate lock device may be attached to the enclosure and a latch bar may be attached to the movable barrier in order to secure access. According to other embodiments, an electronic gate lock device may be attached to a movable barrier, and a latch bar may be attached to the enclosure.

A movable barrier may be in either an open position to permit entry to or exit from a secured area, or a closed position to prevent or otherwise impede ingress to or egress from a secured area. The electronic gate lock device may have a locked state and an unlocked state. In an unlocked state, the movable barrier may be configured to move between an open position and a closed position. In accordance with a representative embodiment corresponding to a locked state, the movable barrier may be configured to move from the open position to the closed position, but not be movable from the closed position to the open position.

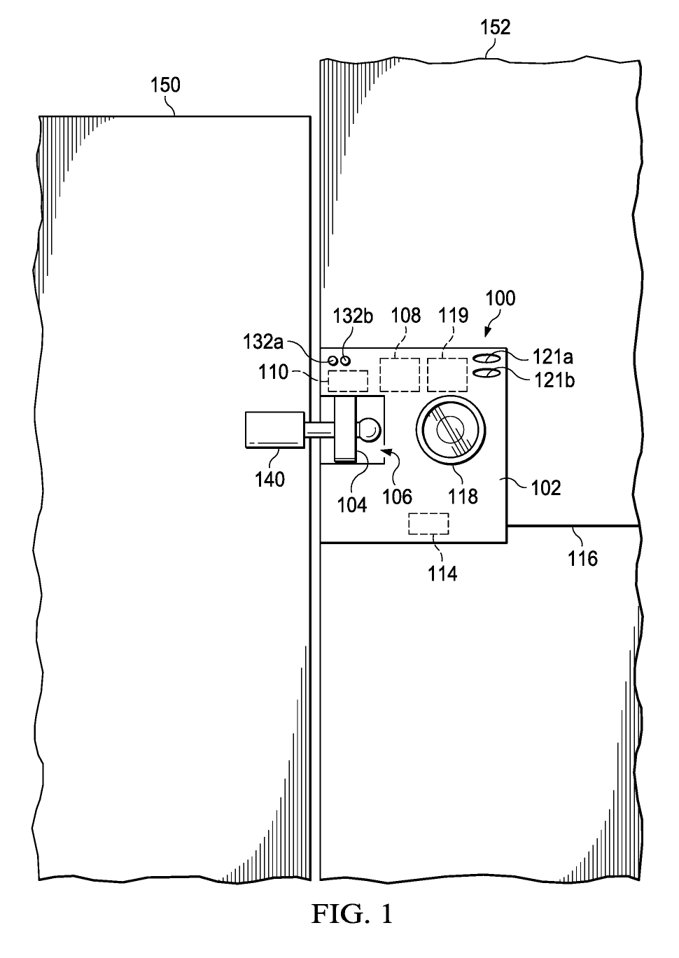

FIG. 1 is a front elevation view of electronic gate lock device 100 and latch bar 140 attached to enclosure 152 and movable barrier 150, respectively, in accordance with a representative embodiment. Electronic gate lock device 100 includes body 102, pawl 104, opening 106, computing device 108, and motor no. Electronic gate lock device 100 further includes battery 114, wired power source 116, camera 118 and gyroscope 119.

In accordance with various embodiments, movable barrier 150 may be a gate, a door, or any other movable barrier. Enclosure 152 may be a fence, a wall, a post, a frame, a doorway, or any other enclosure having an opening for movable barrier 150. Electronic gate lock device 100 is attached to enclosure 152. Latch bar 140 may be a latch bar, a bar, a bolt, a rod, a hook, a pin, a fastener, any other engaging structure, or the like. Latch bar 140 is attached to movable barrier 150 such that latch bar 140 is disposed in opening 106 of electronic gate lock device 100 when movable barrier 150 is in a closed position, and latch bar 140 is disposed outside of opening 106 when movable barrier 150 is in an open position. Latch bar 140 may be attached to movable barrier 150 by various means. For example, latch bar 140 may be attached to movable barrier 150 by screws, nails, bolts, a mounting plate, welding, combinations thereof, or the like. Similarly, electronic gate lock device 100 may be attached to enclosure 152 by screws, nails, bolts, a mounting plate, welding, combinations thereof, or the like.

Pawl 104 is disposed in opening 106. Pawl 104 may comprise a pawl, a tooth-like engagement, a spring-loaded tooth, a latch, any other retaining structure, or the like. Pawl 104 is pivotally connected to the body 102 of electronic gate lock device 100. Pawl 104 is configured to have a locked state (e.g., an active state) and an unlocked state (e.g., a passive state). When pawl 104 is in the locked state, movable barrier 150 may be moved from the open position to the closed position, but may not be moved from the closed position to the open position. However, when pawl 104 is in the unlocked state, movable barrier 150 may be moved from the open position to the closed position or from the closed position to the open position. Thus, access to a secured area may be restricted based on whether pawl 104 is in the locked state or the unlocked state.

Motor 110 is connected to pawl 104. Motor 110 is configured to switch pawl 204 between the locked state and the unlocked state. Computing device 108 is electrically connected to motor 110. Computing device 108 is configured to control motor no. For example, computing device 108 may send signals to motor 110 to switch pawl 104 between the locked state and the unlocked state.

Electronic gate lock device 100 may further include indicator lights 132a, 132b. Indicator lights 132a, 132b may be connected to and controlled by computing device 108. Indicator lights 132a, 132b may be used to indicate an operating condition of electronic gate lock device 100. For example, computing device 108 may turn on indicator lights 132a, 132b to indicate that battery 114 is low, to indicate whether pawl 104 is in the locked state or the unlocked state, to indicate other information regarding a state of electronic gate lock device 100, combinations thereof, or the like. Indicator lights 132a, 132b may comprise light emitting diodes (LEDs), incandescent bulbs, fluorescent bulbs, high-intensity discharge (HID) bulbs, or any other type of light source.

Electronic gate lock device 100 may include a plurality of openings 121a, 121b. For example, electronic gate lock device 100 may include a plurality of openings 121a, 121b which allow a speaker, a microphone, a camera, or another device disposed within body 102 of electronic gate lock device 100 to interact with an area surrounding electronic gate lock device 100 In accordance with a representative aspect, camera 118 may be disposed in a central portion of body 102. Camera 118 and a microphone may be used for any purpose, e.g., such as to authenticate the identity of a potential entrant into a secured area, monitor an area around electronic gate lock device 100 at any time, view current weather or environmental conditions, record the area around electronic gate lock device 100, combinations thereof, or the like. Gyroscope 119 may be configured to orient camera 118. For example, output of camera 118 may be flipped or rotated based on a signal from gyroscope 119 depending on which side of movable barrier 150 electronic gate lock device 100 is disposed. Accordingly, the output of camera 118 may be right-side-up, regardless of orientation of electronic gate lock device 100.

Battery 114 may provide power to computing device 108, motor no, camera 118, gyroscope 119, indicator lights 132a, 132b, the microphone, the speaker, and any other device(s) disposed within body 102. Wired power source 116 may be included to supply power to battery 114.

Body 102 of gate lock device 100 includes a major surface. The major surface of body 102 is disposed opposite a surface of body 102 which is adjacent enclosure 152. Gate lock device 100 and latch bar 140 are configured such that latch bar 140 enters and exits opening 106 in a direction substantially perpendicular to (e.g., substantially normal, or substantially orthogonal to) the major surface of body 102. More specifically, when movable barrier 150 is moved from the open position to the closed position, movable barrier 150 rotates around a pivot (e.g., an axis of rotation distally disposed from latch bar 140), latch bar 140 moves from a position outside of opening 106 to a position within opening 106 in a direction perpendicular to the major surface of body 102, and pawl 104 engages latch bar 140. When movable barrier 150 is moved from the closed position to the open position, movable barrier 150 rotates around the pivot, and latch bar 140 moves from a position within opening 106 to a position outside of opening 106 in a direction perpendicular to the major surface of body 102.

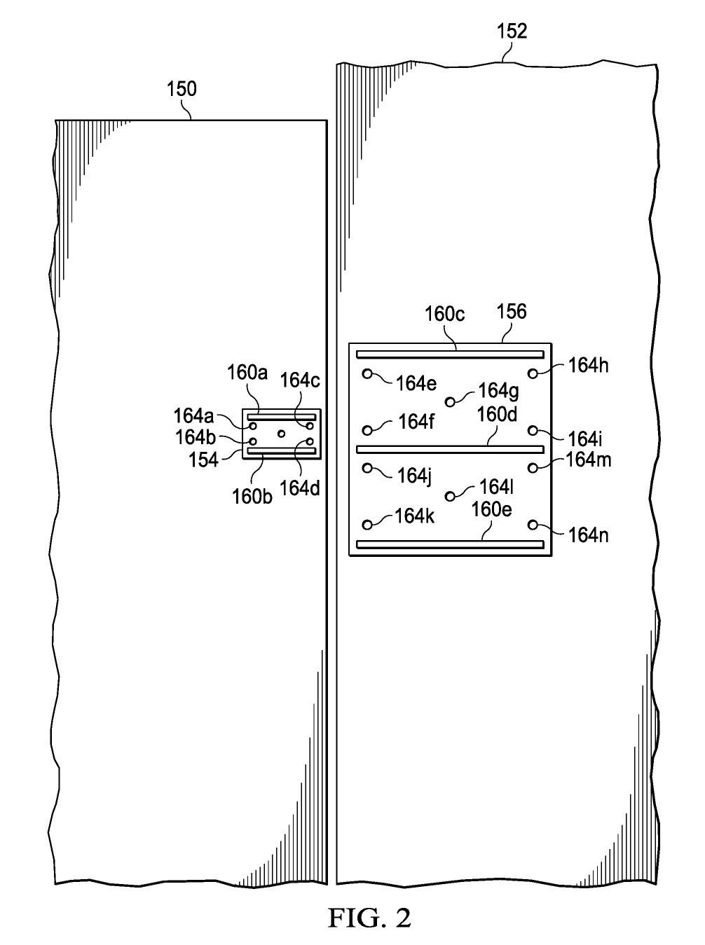

FIG. 2 is a front elevation view of latch bar mounting plate 154 and device mounting plate 156, in accordance with a representative embodiment. Latch bar mounting plate 154 may be used to attach latch bar 140 to movable barrier 150. Device mounting plate 156 may be used to attach electronic gate lock device 100 to enclosure 152. Latch bar mounting plate 154 may be attached to movable barrier 150 by screws, nails, bolts, welding, combinations thereof, or the like. Similarly, device mounting plate 156 may be attached to enclosure 152 by screws, nails, bolts, welding, combinations thereof, or the like. For example, latch bar mounting plate 154 may be attached to movable barrier 150, and device mounting plate 156 may be attached to enclosure 152 by screws provided in a plurality of screw holes 164a-n formed in each of latch bar mounting plate 154 and device mounting plate 156.

Latch bar 140 and electronic gate lock device 100 may be attached to latch bar mounting plate 154 and device mounting plate 156, respectively, by way of, e.g., a system of rails. Latch bar mounting plate 154 and device mounting plate 156 may each include horizontal rails 160a-e. Horizontal rails 160a-e may include grooves or recesses formed in surfaces of latch bar mounting plate 154 and device mounting plate 156. Alternatively, conjunctively, or sequentially, horizontal rails 160a-e may include projections that extend from surfaces of latch bar mounting plate 154 and device mounting plate 156. Horizontal rails 160a-e may be provided such that latch bar 140 and electronic gate lock device 100 may be attached to latch bar mounting plate 154 and device mounting plate 156, respectively, such that neither latch bar 140 nor electronic gate lock device 100 can be removed when pawl 104 is in the locked state.

Electronic gate lock device 100 and latch bar 140 may each include complementary rails. For example, if horizontal rails 160a-e include recesses or grooves formed in device mounting plate 156 and latch bar mounting plate 154, then complementary rails may be configured to include projections extending from back surfaces of electronic gate lock device 100 and latch bar 140. Alternatively, conjunctively, or sequentially, if horizontal rails 160a-e include projections extending from surfaces of device mounting plate 156 and latch bar mounting plate 154, then complementary rails may be configured to include recesses or grooves formed in back surfaces of electronic gate lock device 100 and latch bar 140.

In an embodiment, electronic gate lock device 100 may be configured to include an internal locking device. The internal locking device may include at least one of a bolt, a tab, a bar, a latch configured to lock electronic gate lock device 100 onto device mounting plate 156, or the like, when pawl 104 is in the locked state. The internal locking device may allow electronic gate lock device 100 to be mounted to device mounting plate 156 when pawl 104 is in either the locked or the unlocked state. The internal locking device may be further configured to secure electronic gate lock device 100 to device mounting plate 156 when pawl 104 is in the locked state.

The internal locking device may be separately operable from pawl 104. For example, the internal locking device may have a fastened state and an unfastened state. Electronic gate lock device 100 may be removable from device mounting plate 156 when the internal locking device is in the unfastened state, and electronic gate lock device 100 may be secured to device mounting plate 156 when the internal locking device is in the fastened state. Motor 110 may be connected to the internal locking device. For example, motor 110 may switch the internal locking device between the fastened state and the unfastened state. Computing device 108 may be configured to control the internal locking device. For example, computing device 108 may send a signal to motor 110 to switch the internal locking device between the fastened state and the unfastened state.

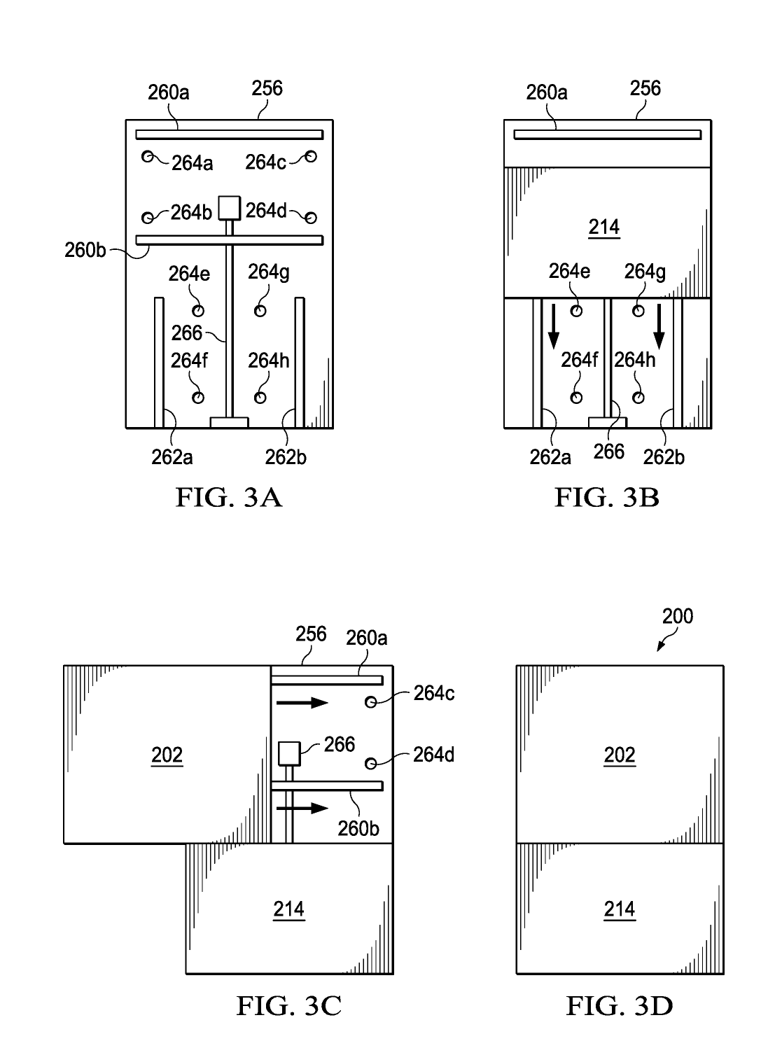

FIGS. 3A-3D illustrate front elevation views of a method of mounting electronic gate lock device 200 onto device mounting plate 256 in accordance with a representative embodiment. As representatively illustrated in FIG. 3A, device mounting plate 256 may include a plurality of screw holes 264a-h, horizontal rails 260a, 260b, and vertical rails 262a, 262b, and power router 266. Device mounting plate 256 may be attached to an enclosure or a movable barrier by screws, nails, bolts, welding, combinations thereof, or the like. For example, device mounting plate 256 may be attached to an enclosure or a movable barrier by screws disposed in the plurality of screw holes 264a-h. Horizontal rails 260a, 260b and vertical rails 262a, 262b may be rails that project from a major surface of device mounting plate 256, or may be recessed or grooved into the major surface of device mounting plate 256.

As representatively illustrated in FIG. 3D, electronic gate lock device 200 includes body 202 and battery 214. Body 202 may include horizontal complementary rails. The horizontal complementary rails may include projections which extend from a back surface of electronic gate lock device 200, or grooves or recesses formed in the back surface of electronic gate lock device 200. The horizontal complementary rails may be coupled to horizontal rails 260a, 260b of device mounting plate 256 to fasten body 202 to device mounting plate 256. Battery 214 may include vertical complementary rails. The vertical complementary rails may include projections which extend from a back surface of battery 214, or grooves or recesses formed in the back surface of battery 214. The vertical complementary rails may be coupled to vertical rails 262a, 262b of device mounting plate 256 to fasten battery 214 to device mounting plate 256.

As representatively illustrated in FIG. 3B, electronic gate lock device 200 is mounted to device mounting plate 256 by first sliding the vertical complementary rails of battery 214 onto vertical rails 262a, 262b to attach battery 214 to device mounting plate 256. Then, as representatively illustrated in FIG. 3C, the horizontal complementary rails of body 202 are slid onto horizontal rails 260a, 260b. Body 202 is secured to device mounting plate 256 when electronic gate lock device 200 is in the locked state, but is removable from device mounting plate 256 when electronic gate lock device 200 is in the unlocked state.

When electronic gate lock device 200 is mounted to device mounting plate 256, power router 266 may provide power from battery 214 to body 202 of electronic gate lock device 200. In some embodiments, power router 266 may not be included and battery 214 may be substantially directly connected to body 202 of electronic gate lock device 200.

Body 202 and battery 214 of electronic gate lock device 200 may be attached to device mounting plate 256 by various combinations of vertical or horizontal rails, and in various sequences. For example, both body 202 and battery 214 may be attached by horizontal rails, by vertical rails, or body 202 may be attached by vertical rails and battery 214 may be attached by horizontal rails. Alternatively, conjunctively, or sequentially, battery 214 may be attached before body 202, or body 202 and battery 214 may be attached at a same time.

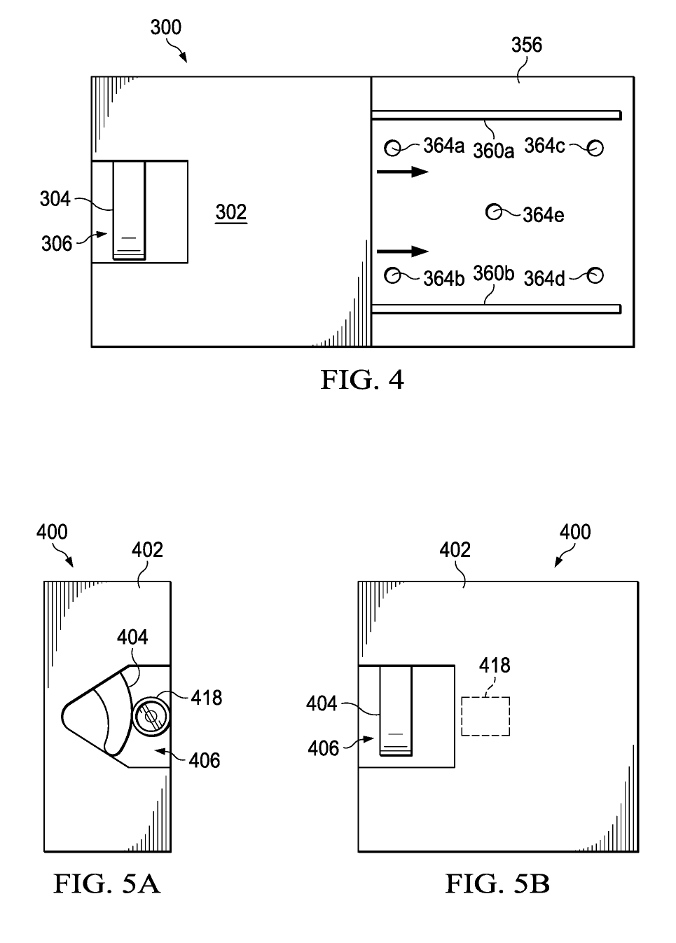

FIG. 4 illustrates a front elevation view of a method of attaching electronic gate lock device 300 to device mounting plate 356, in accordance with a representative embodiment. Electronic gate lock device 300 includes body 302, pawl 304, and opening 306. Device mounting plate 356 includes horizontal rails 360a, 360b and a plurality of screw holes 364a-d. In a representative embodiment, device mounting plate 356 is attached to an enclosure or a movable barrier by screws disposed in screw holes 364a-d; it will be appreciated, however, that other mechanisms of attachment are also possible. For example, device mounting plate 356 may be attached to an enclosure or a movable barrier by screws, nails, bolts, welding, combinations thereof, or the like.

Horizontal rails 360a, 360b may project from a major surface of device mounting plate 356, or may be recessed or grooved into the major surface of device mounting plate 356. Body 302 of electronic gate lock device 300 may include complementary rails. The complementary rails may be recessed or grooved into a back surface of electronic gate lock device 300, or may project from the back surface of electronic gate lock device 300. Electronic gate lock device 300 may be attached to device mounting plate 356 by way of horizontal rails 360a, 360b and complementary rails. As representatively illustrated in FIG. 4, electronic gate lock device 300 may be attached to device mounting plate 356 by sliding the complementary rails of electronic gate lock device 300 onto horizontal rails 360a, 360b of device mounting plate 356.

FIG. 5A and FIG. 5B are a side elevation view and a front elevation view, respectively, of electronic gate lock device 400, in accordance with a representative embodiment. Electronic gate lock device 400 includes body 402, pawl 404, opening 406, and camera 418. Camera 418 may be disposed within body 602 of electronic gate lock device 400. More specifically, camera 418 may be disposed in body 402 such that camera 418 extends through an aperture formed in opening 406 of body 402, as representatively illustrated in FIG. 5A.

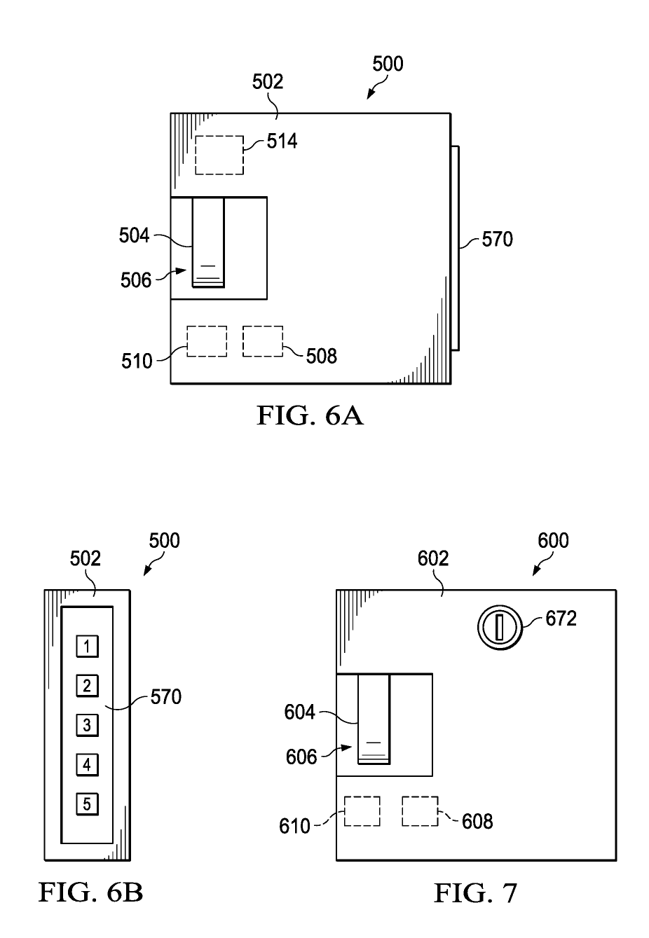

FIG. 6A and FIG. 6B are a front elevation view and a side elevation view, respectively, of electronic gate lock device 500, in accordance with a representative embodiment. Electronic gate lock device 500 includes body 502, pawl 504, opening 506, computing device 508, motor 510, battery 514, and keypad 57o. Battery 514 may supply power to computing device 508, motor 510, keypad 570, and any other devices included in electronic gate lock device 500. Keypad 570 is a representative example of an input device, in accordance with an embodiment. In a representative aspect, keypad 570 may be connected to computing device 508. Computing device 508 may be configured to control motor 510 in response to a signal from keypad 570. More specifically, if a user enters a predetermined key sequence into keypad 570, computing device 508 may signal motor 510 to switch pawl 504 from a locked state to an unlocked state. According to at least one embodiment, keypad 570 may be disposed on a side surface of body 502 of electronic gate lock device 500, as illustrated in FIGS. 6A and 6B. According to various other embodiments, keypad 570 may be disposed on a front surface, a top surface, or a bottom surface of body 502 of electronic gate lock device 500.

FIG. 7 is a front elevation view of electronic gate lock device 600 in accordance with a representative embodiment. Electronic gate lock device 600 includes body 602, pawl 604, opening 606, computing device 608, and motor 610. Body 602 further includes manual override 672. In a representative aspect, manual override 672 may comprise a key hole. Manual override 672 may be used, e.g., to bypass computing device 608 and motor 610 to control pawl 604. For example, manual override 672 may be used to switch pawl 604 from the locked state to the unlocked state, or from the unlocked state to the locked state without using computing device 608. A user may use manual override 672 to lock or unlock pawl 604 in cases where, e.g., the user does not have an external input device, there is a connection error between electronic gate lock device 600 and an external input device, there is a loss of power to electronic gate lock device 600, combinations thereof, or the like. Manual override 672 may also be used to fasten or unfasten internal locks used to fasten electronic gate lock device 600 to a device mounting plate attached to an enclosure or a movable barrier, either together with or independently from the locking and unlocking action of the pawl 604. For example, manual override 672 may be used to switch the internal locks from the fastened state to the unfastened state, or from the unfastened state to the fastened state without using computing device 608.

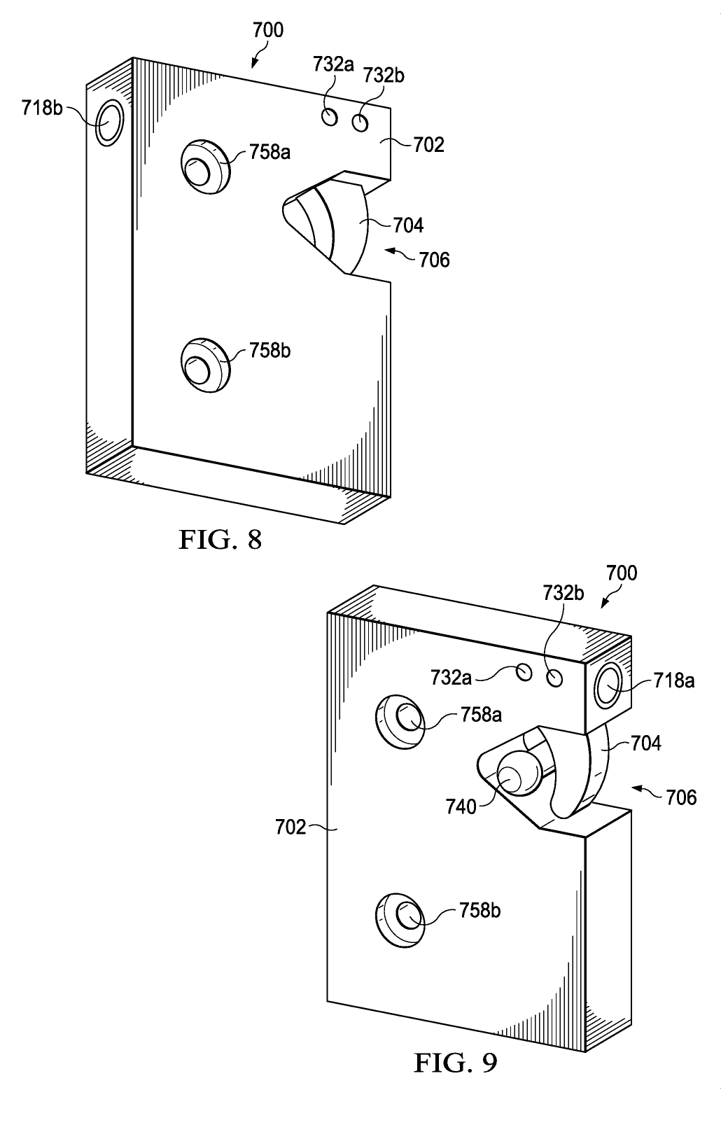

FIG. 8 is a perspective view of electronic gate lock device 700 in accordance with a representative embodiment. Electronic gate lock device 700 may be attached to an enclosure (e.g., a fence, a wall, or the like), a stationary structure (e.g., a post, a doorway, or the like), or a movable barrier (e.g., a gate, a door, or the like). In a representative aspect, electronic gate lock device 700 may be used to restrict access to a secured area.

Electronic gate lock device 700 comprises a body 702 having an opening 706, indicator lights 732a, 732b, bolt holes 758a, 758b, and cameras 718a, 718b. Pawl 704 is disposed in opening 706. Pawl 704 may comprise a pawl, a tooth-like engagement, a spring-loaded tooth, a latch, any other retaining structure, combinations thereof, or the like. Pawl 704 is pivotally connected to the body 702 of electronic gate lock device 700. Pawl 704 is configured to have a locked state (i.e., an active state) and an unlocked state (i.e., a passive state). When pawl 704 is in the locked state, the movable barrier may be moved from the open position to the closed position, but may not be moved from the closed position to the open position. However, when pawl 704 is in the unlocked state, the movable barrier may be moved from the open position to the closed position, or from the closed position to the open position. Thus, access to a secured area may be restricted based on whether pawl 704 is in the locked state or the unlocked state.

Indicator lights 732a, 732b may be used to indicate the status of electronic gate lock device 700. For example, indicator lights 732a, 732b may be used to indicate whether a battery is low, whether pawl 704 is in the locked state or the unlocked state, to indicate other information regarding a state of electronic gate lock device 100, combinations thereof, or the like. Indicator lights 732a, 732b may comprise light emitting diodes (LEDs), incandescent bulbs, fluorescent bulbs, high-intensity discharge (HID) bulbs, or any other type of light source. Bolt holes 758a, 758b may be used to secure body 702 of electronic gate lock device 700 to the enclosure. For example, a plurality of bolts may be disposed through bolt holes 758a, 758b to attach body 702 to the enclosure. As representatively illustrated in FIG. 8, camera 718b may be disposed in the backside of electronic gate lock device 700 opposite opening 706. Camera 718b may be used to record an area around electronic gate lock device 700.

FIG. 9 is a perspective view of electronic gate lock device 700 and latch bar 740 in accordance with a representative embodiment. Latch bar 740 may be attached to an enclosure (e.g., a fence, a wall, or the like), a stationary structure (e.g., a post, a doorway, or the like), or a movable barrier (e.g., a gate, a door, or the like). According to various embodiments, electronic gate lock device 700 may be attached to an enclosure, and latch bar 740 may be attached to a movable barrier. According to other embodiments, electronic gate lock device 700 may be attached to a movable barrier, and latch bar 740 may be attached to the enclosure.

Electronic gate lock device 700 and latch bar 740 may be attached to a gate and an enclosure such that latch bar 740 is disposed in opening 706 when the movable barrier is in the closed position, and latch bar 740 is disposed outside of opening 706 when the movable barrier is in the open position. More specifically, pawl 704 allows latch bar 740 to enter or exit opening 706 when pawl 704 is in the unlocked state. When pawl 704 is in the locked state, pawl 704 allows latch bar 740 to enter opening 706, but traps, fastens, secures, or otherwise prevents latch bar 740 from exiting opening 706. Electronic gate lock device 700 may include camera 718a disposed on the same side of body 702 as opening 706 (e.g., the front side). Camera 718a may be used to record an area around electronic gate lock device 700.

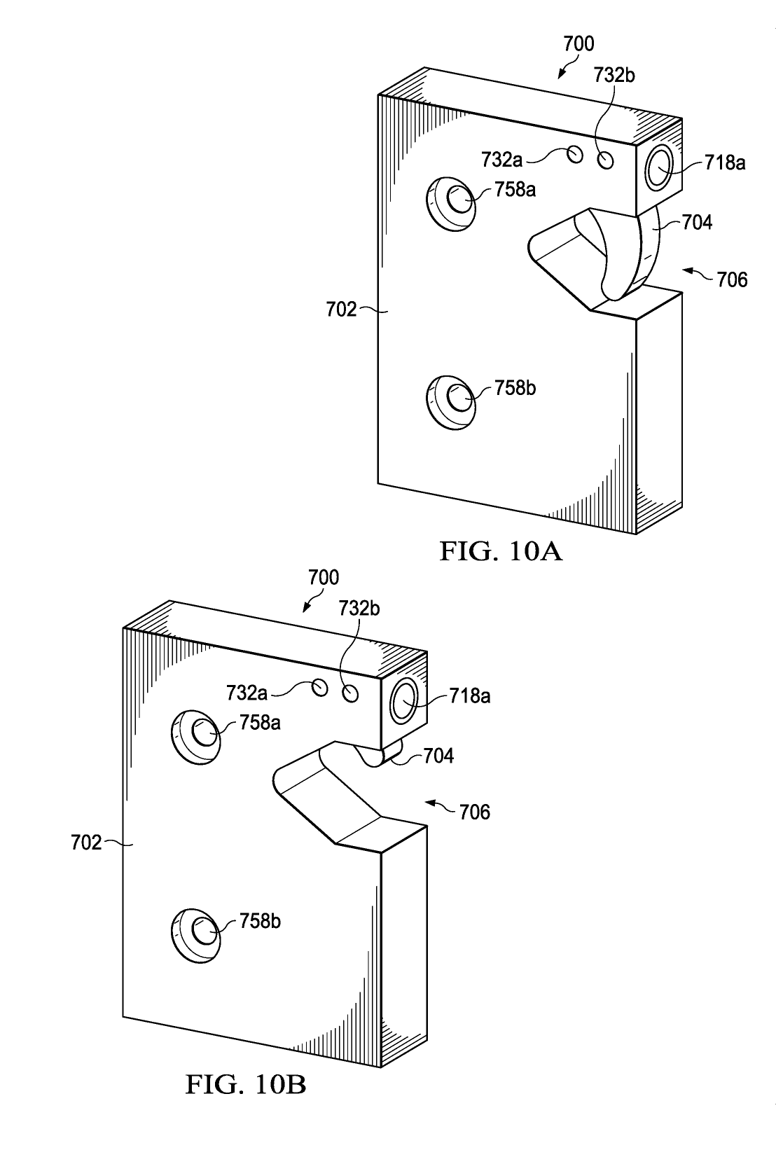

FIG. 10A and FIG. 10B are perspective views of electronic gate lock device 700 in accordance with a representative embodiment where pawl 704 is in an extended position and a retracted position, respectively. Pawl 704 is in the extended position unless the movable barrier is moved from the closed position to the open position, or from the open position to the closed position. When the movable barrier is moved from the closed position to the open position, or from the open position to the closed position, latch bar 740 contacts pawl 704 and pivots pawl 704 from the extended position to the retracted position. Pawl 704 then pivots back to the extended position when latch bar 740 no longer contacts pawl 704. Pawl 704 may be spring-loaded, a spring may be attached to pawl 704 or body 702, or another passive force, such as gravity, may be used such that pawl 704 automatically moves to the extended position unless contacted by latch bar 740.

When pawl 704 is in the unlocked state, pawl 704 is configured to pivot from the extended position to the retracted position when the movable barrier is moved from the open position to the closed position or from the closed position to the open position. Pawl 704 may retain latch bar 740 in opening 706 when pawl 704 is in the unlocked state and the movable barrier is in the closed position, unless a user opens the movable barrier. When pawl 704 is in the locked state, pawl 704 is configured to pivot from the extended position to the retracted position when the movable barrier is moved from the open position to the closed position, but pawl 704 is configured to secure latch bar 740 in opening 706 by remaining fixed in the extended position once the movable barrier is in the closed position and latch bar 740 is disposed in opening 706. When pawl 704 is in the locked state, latch bar 740 cannot exit opening 706, and access to the secured area may be accordingly restricted.

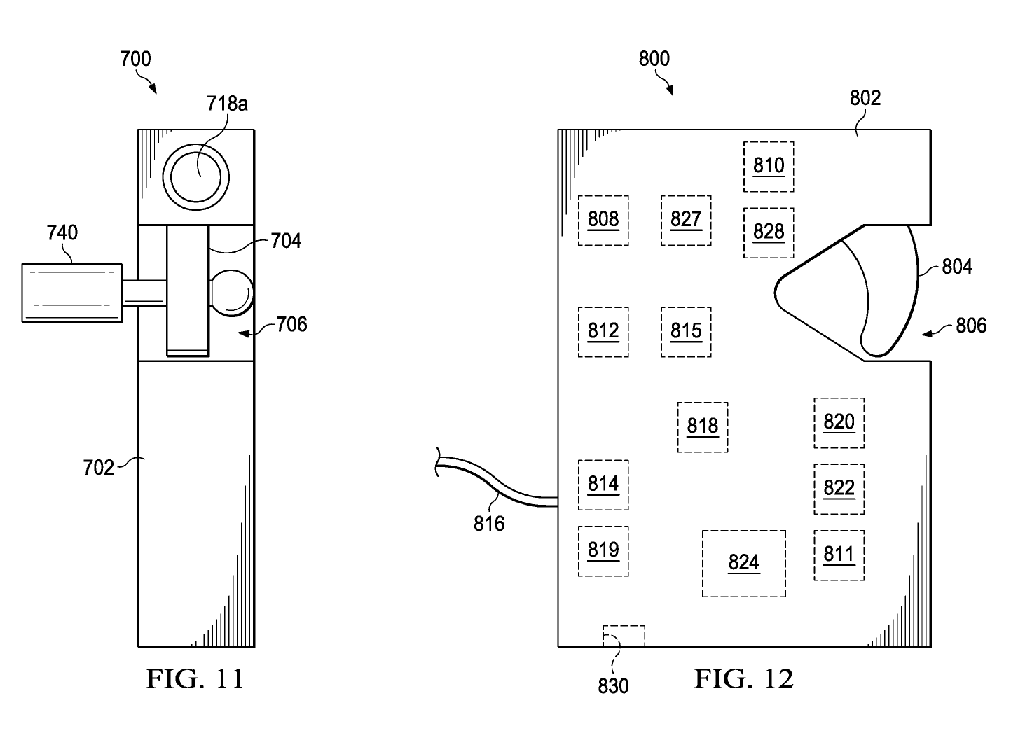

FIG. 11 is a front elevation view of electronic gate lock device 700 and latch bar 740 in accordance with a representative embodiment. When latch bar 740 is disposed within opening 706, latch bar 740 is secured by pawl 704. When pawl 704 is in the extended position, pawl 704 may extend beyond the lower edge of opening 706. For example, a recess may be formed in a lower portion of opening 706 such that pawl 704 may extend into the recess.

FIG. 12 is a cross-sectional view of electronic gate lock device 800 in accordance with a representative embodiment. Electronic gate lock device 800 includes a body 802 having an opening 806 formed therein. Pawl 804 is disposed within opening 806. Pawl 804 is pivotally connected to body 802. Electronic gate lock device 80o may include a plurality of components at least partially disposed within body 802. For example, electronic gate lock device 80o may include computing device 808, motor 810, a memory card 811, wireless communication device 812, battery 814, power generation device 815, camera 818, speaker 82o, microphone 822, weather monitoring device 824, gyroscope 819, radio-frequency identification (RFID) writer 827 and latch bar detection device 828 disposed at least partially within body 802.

Body 802 may include a plurality of openings (e.g., vents, holes, or the like) which allow at least some of the plurality of components to interface with the external environment of electronic gate lock device 800. For example, body 802 may include openings for power generation device 815, camera 818, speaker 820, microphone 822, weather monitoring device 824, and latch bar detection device 828. Electronic gate lock device 80o may further include wired power source 810 and wired communication port 830. Wired power source 810 and wired communication port 830 may be disposed in additional openings formed in body 802. Wired power source 810 and wired communication port 830 may be optionally included as auxiliary power. Body 802 of electronic gate lock device 800 may be configured to be theft-proof, tamper-proof, shock-proof, water-proof, or the like.

Motor 810 is connected to pawl 804. Motor 810 is configured to switch pawl 804 between the locked state and the unlocked state. Computing device 808 is electrically connected to motor 810. Computing device 808 is configured to control motor 810. For example, computing device 808 may send signals to motor 810 to switch pawl 804 between the locked state and the unlocked state. The status of pawl 804, computing device 808, or motor 810 may be presented to a user via a plurality of output devices, or via a plurality of indicator lights disposed on body 802.

Computing device 808 may have internal memory or may communicate with memory card 811 for memory. Memory card 811 may be any type of memory card such as a subscriber identity module (SIM) card, a flash card, a memory cartridge, combinations thereof, or the like. Memory card 811 may be removable from electronic gate lock device 800. As such, a user may update the software or firmware of electronic gate lock device 800 by replacing memory card 811.

Wireless communication device 812 may be connected to computing device 808. Wireless communication device 812 generally provides wireless communication between computing device 808 and external devices. Representative external devices may include predetermined verbal commands and passwords a computer, a cellphone, a tablet, a remote, a key fob, a wall-mounted switch, a weather monitoring device, a router, a keypad, a motion detector, a camera, radio-frequency identification (RFID) cards, tags, or tokens, or the like. Wireless communication device 812 may communicate with external devices by one or more wireless communication protocols (e.g., Bluetooth, near-field communication (NFC), WiFi, radio-frequency identification (RFID), radio-frequency (RF), infrared radiation (IR), Z-Wave, ZigBee, 6LoWPAN, Thread, Long-Term Evolution (LTE), or any other wireless communication protocols, whether now known or hereafter derived).

Elements of a plurality of device components (e.g., computing device 808, motor 810, memory card 811, wireless communication device 812, battery 814, power generation device 815, camera 818, speaker 82o, microphone 822, weather monitoring device 824, latch bar detection device 828, RFID writer 827, gyroscope 819, or the like) may be powered by at least one of battery 814, power generation device 815, or wired power source 816. Power generation device 815 or wired power source 816 may be configured to charge battery 814. Battery 814 may be on-board and disposed within body 802 or may be external and located outside of body 802. Power generation device 815 may include a solar panel (which may be configured to generate power from solar energy) or a kinetic power generator (which may be configured to generate power from kinetic movement).

Camera 818, speaker 820, and microphone 822 may be communicatively connected to computing device 808. Computing device 808 may be configured to receive or send information from/to camera 818, speaker 820, microphone 822, other devices connected to the electronic gate lock device's network, or any other external devices through wireless communication device 812. The external devices may use at least one of camera 818 and microphone 822 to record an area surrounding electronic gate lock device 800. Computing device 808 and the external devices may use at least one of camera 818 or microphone 822 to authenticate the identity of a potential entrant. For example, computing device 808 may authenticate the identity of a potential entrant based on data obtained by camera 818 (e.g., face recognition, iris pattern, or the like) or microphone 822 (e.g., voice recognition, pass phrase, or the like), and may signal motor 810 to switch pawl 804 to the unlocked state once the potential entrant's identity has been authenticated.

Gyroscope 819 may be configured to orient camera 818. For example, the output of camera 818 may be flipped or rotated based on a signal from gyroscope 819 depending on which side of movable barrier 850 electronic gate lock device 800 is disposed. Accordingly, the output of camera 818 may be right-side-up, regardless of orientation of electronic gate lock device 800.

Wireless communication device 812 may be configured to communicate signals between at least one of camera 818, microphone 822, speaker 820, other devices connected to the electronic gate lock device's network, or any other external device(s). Accordingly, a user may verify the identity of a potential entrant based on a signal from camera 818 or microphone 822, and may use the external device to signal computing device 808 to switch pawl 804 to the unlocked state once the potential entrant's identity has been authenticated. The user can also communicate with a potential entrant through microphone 822 and speaker 820 from any location using external devices. Wireless communication device 812 may also communicate notifications to external devices based on the status of electronic gate lock device 800 (including, for example, a battery percentage or a low battery warning).

Weather monitoring device 824 may include a plurality of sensors, such as a temperature sensor, a motion sensor, a humidity sensor, a light sensor, a seismic sensor, a vibration sensor, an air quality monitor, combinations thereof, or the like. Weather monitoring device 824 may be used to detect or otherwise measure environmental changes occurring in an area surrounding electronic gate lock device 800. Weather monitoring device 824 may be connected to computing device 808, and computing device 808 may be configured to communicate weather data collected by weather monitoring device 824 to external devices through wireless communication device 812. Weather monitoring device 824 may use a seismic sensor coupled with a vibration sensor in order to detect theft of or tampering with electronic gate lock device 800. Weather monitoring device 824 may be used to rule out false alarms caused by current weather conditions, natural phenomena (e.g., earthquakes) or the like.

Latch bar detection device 828 may be connected to computing device 808. Latch bar detection device 828 may be used to detect whether a latch bar is disposed in opening 806 of electronic gate lock device 800. Computing device 808 may switch pawl 804 from the unlocked state to the locked state when the movable barrier is moved from an open position to a closed position. For example, computing device 808 may be configured to switch pawl 804 from the unlocked state to the locked state when a latch bar is detected in opening 806 by latch bar detection device 828.

Computing device 808 may be configured to switch pawl 804 from the unlocked state to the locked state after, e.g., a predetermined duration of time. For example, after computing device 808 switches pawl 804 from the locked state to the unlocked state, computing device 808 may switch pawl 804 back to the locked state after a predetermined period of time. The predetermined period of time may be a duration of time such as, e.g., about 1 second, about 3 seconds, about 5 seconds, about 10 seconds, about 15 seconds, about 30 seconds, or any other time between about 1 second and about 3 minutes. Computing device 808 of electronic gate lock device 80o may be programmed to detect a predetermined number of openings and closings of the movable barrier and automatically switch pawl 804 to the locked state after the predetermined number of openings and closings has been achieved. Computing device 808 may also be programmed to switch pawl 804 to the locked state once a usage confirmation has been received. For example, a gardener may communicate usage confirmation to computing device 808 through any of the above-described external devices once they have finished gardening, or a deliveryman may communicate usage confirmation once a package has been delivered.

Wired communication port 830 may be connected to computing device 808. Wired communication port 830 may be configured to allow external devices to communicate with computing device 808 by wired communication. Wired communication port 83o maybe, e.g., a Universal Serial Bus (USB) port, an Ethernet port, a FireWire port, a Thunderbolt port, or any other type of wired communication port, whether now known or hereafter derived.

RFID writer 827 may be used to configure an RFID card, tag, or token. For example, RFID writer 827 may be used to configure an RFID card to allow a potential entrant access to the secured area. Computing device 808 may be configured to control RFID writer 827. RFID cards may be tracked by computing device 808 such that a discrete RFID card can be used to access the secured area a predetermined number of times.

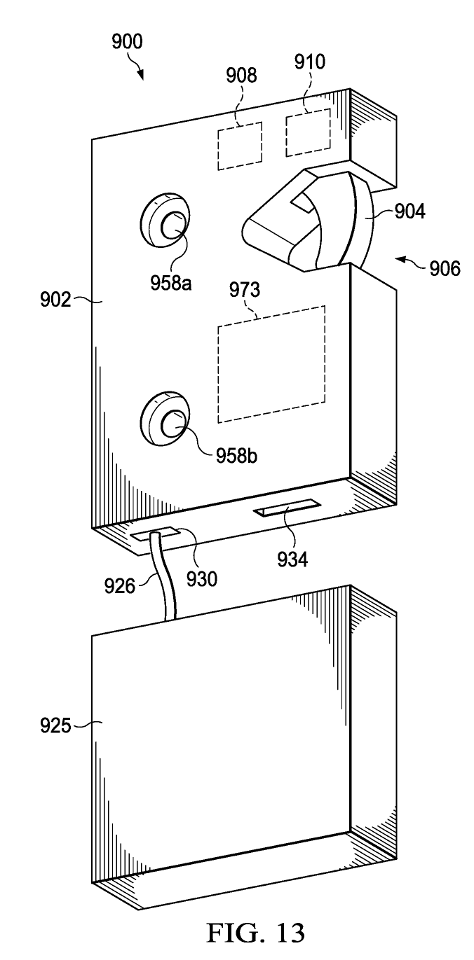

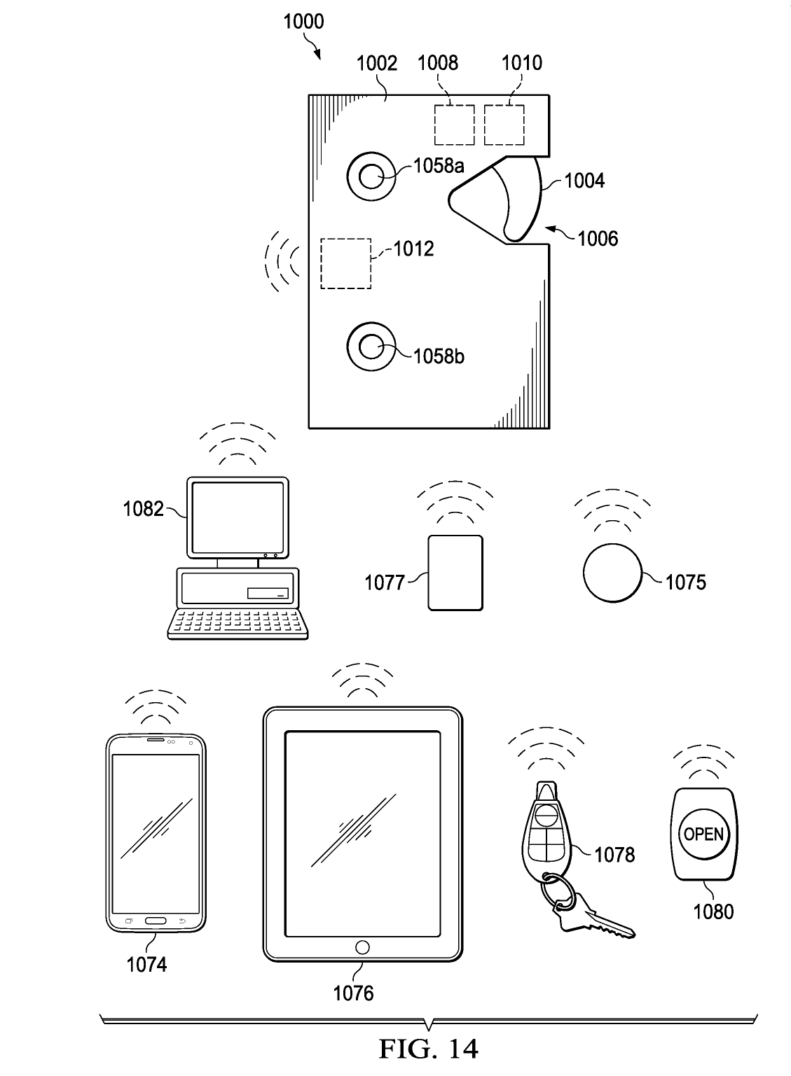

FIG. 13 is a perspective view of electronic gate lock device 900 having wired input device 925 connected thereto, in accordance with a representative embodiment. Electronic gate lock device 900 includes body 902, which includes opening 906, and pawl 904 disposed in opening 906. Pawl 904 is pivotally connected to body 902. Electronic gate lock device 900 further includes motor 910, which is configured to switch pawl 904 between a locked state and an unlocked state. Electronic gate lock device 90o further includes computing device 908, which is configured to control motor 910. Body 902 further comprises wired communication port 930. Wired communication port 93o may comprise a USB port, an Ethernet port, a FireWire port, a Thunderbolt port, other wired communication port, or the like. Wired input device 925 may be connected to electronic gate lock device 900 through wired input cord 926, which is connected to wired communication port 930. According to various embodiments, wired input cord 926 may comprise a USB cable, an Ethernet cable, a FireWire cable, a Thunderbolt cable, other wired input cable or cord, or the like.

Wired input device 925 may comprise at least one of a cell phone, a tablet, a computer, a remote, a weather monitoring device, a sensor, a keypad, a biometric authentication device, or any other type of input device. Wired communication port 930 may be configured to allow wired input device 925 to be connected to electronic gate lock device 900—even if electronic gate lock device 900 does not include a wireless communication device, or if the wireless communication device is inoperable. Wired communication port 930 may also aid in the installation of firmware or other startup software to electronic gate lock device 900 or wired input device 925.

Wired input device 925 may communicate with computing device 908. For example, wired input device 925 may be used to authenticate a potential entrant's credentials or identity. Once a potential entrant's credentials or identity have been authenticated, wired input device 925 may instruct computing device 908 to signal motor 910 to switch pawl 904 from the locked state to the unlocked state, or from the unlocked state to the locked state.

Body 902 of electronic gate lock device 900 may further include at least one bolt hole 958. In a particular embodiment, body 902 may include two bolt holes 958a, 958b. Bolt holes 958a, 958b may be used to attach the device to an enclosure or a movable barrier by way of bolts, screws, other fastener devices, or the like. According to at least one embodiment, bolts, screws, or other fastener devices may be used to fasten electronic gate lock device 900 to the enclosure. Alternatively, conjunctively, or sequentially, the movable barrier may include unique patterns that require an implementation-specific tool in order to attach or remove electronic gate lock device 900 from the enclosure or the movable barrier.

Memory slot 934 may be formed in body 902 of electronic gate lock device 900. Memory slot 934 may be provided so that a memory card (e.g., such as a USB flash drive, a Flash Memory Stick, a Secure Digital (SD) card, or the like) can be connected to electronic gate lock device 900 as disposed in memory slot 934. Memory slot 934 may be connected to computing device 908 such that computing device 908 communicates with an attached memory card. An attached memory card may be used to alter settings of computing device 908, install updated software/firmware, or the like.

According to various embodiments, electronic gate lock device 900 may include a screen 973 disposed on an outside surface of body 902. Screen 973 may be configured to display visual information, such as status of electronic gate lock device 900, or the like. Screen 973 may include touch screen controls, and may be used to control computing device 908 and motor 910.

FIG. 14 is a side elevation view of electronic gate lock device 1000 in addition to several external input devices in accordance with a representative embodiment. Electronic gate lock device 1000 includes body 1002, which includes opening 1006 and bolt holes 1058a, 1058b which may be used to attach or mount electronic gate lock device 1000 to an enclosure or a movable barrier. Electronic gate lock device 1000 includes pawl 1004 that is disposed in opening 1006 and pivotally connected to body 1002. Electronic gate lock device 1000 further includes motor 1010 configured to switch pawl 1004 between a locked state and an unlocked state. Electronic gate lock device 1000 further includes computing device 1008, which is configured to control motor 1010. Electronic gate lock device 1000 further includes wireless communication device 1012, which is configured to send or receive signals to or from computing device 1008 and external input devices. Representative external input devices include predetermined verbal commands and passwords, cell phone 1074, RFID token 1075, tablet 1076, RFID card 1077, key fob 1078, remote 1080, and computer 1082. External input devices may be configured to communicate with wireless communication device 1012 to send signals to computing device 1008 to instruct motor 1010 o switch pawl 1004 between the locked state and the unlocked state. Cell phone 1074, tablet 1076, and computer 1082 may include an application or a website address for communicating with electronic gate lock device 1000 (e.g., a graphical user interface). Various external input devices may be used to authenticate or otherwise identify a potential entrant before permitting a potential entrant to control electronic gate lock device 1000.

Wireless communication device 1012 may communicate with external input devices through various wireless communication protocols. For example, wireless communication device 1012 may communicate with external input devices by one or more of Bluetooth, near-field communication (NFC), WiFi, radio-frequency identification (RFID), radio-frequency (RF), infrared radiation (IR), Z-Wave, ZigBee, 6LoWPAN, Thread, Long-Term Evolution (LTE), or other wireless communication protocol.

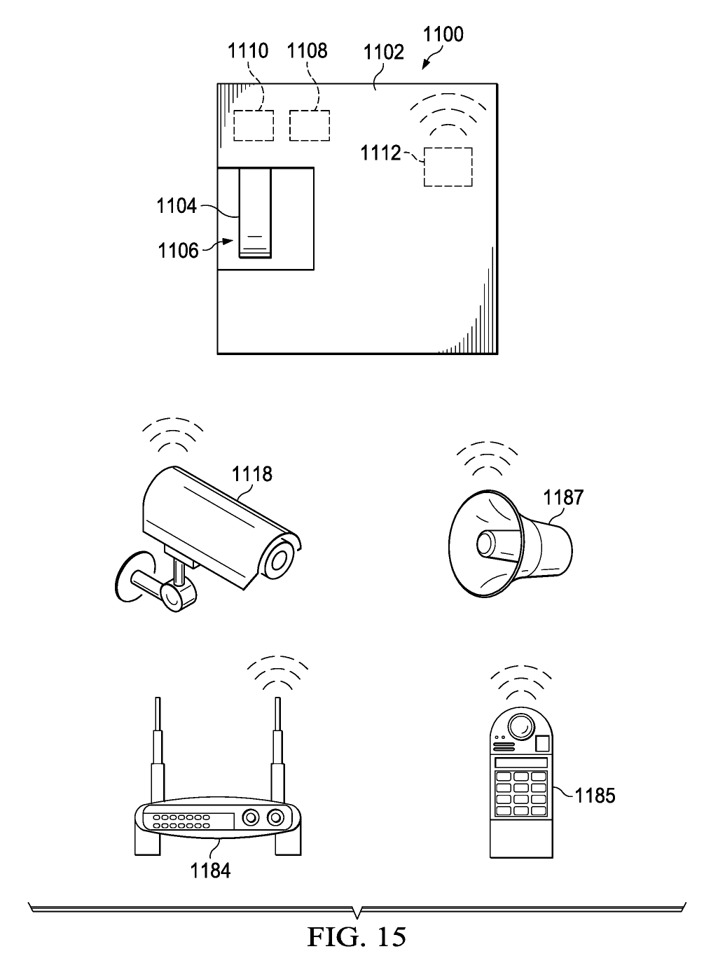

FIG. 15 is a front elevation view of electronic gate lock device 1100 in addition to several external input devices, in accordance with a representative embodiment. Electronic gate lock device 1100 includes body 1102, which includes opening 1106 and bolt holes 1158a, 1158b which may be used to attach or mount electronic gate lock device 1000 to an enclosure or a movable barrier. Electronic gate lock device 1100 includes pawl 1104 that is disposed in opening 1106 and pivotally connected to body 1102. Electronic gate lock device 1100 further includes motor 1110 configured to switch pawl 1104 between a locked state and an unlocked state. Electronic gate lock device 1100 further includes computing device 1108, which is configured to control motor 1110. Electronic gate lock device 1100 further includes wireless communication device 1112, which is configured to send or receive signals to or from computing device 1108 and a plurality of external input devices. Representative external input devices include network hub 1184, camera 1118, camera with keypad 1185, siren 1187, or other devices connected to the wired or wireless network of electronic gate lock device 1100. Plural external input devices may be configured to communicate with wireless communication device 1112 to send signals to/from computing device 1108. Network hub 1184 may be a wireless router, a network hub, or the like, and may provide wireless communication between electronic gate lock device 1100 and various external devices. Camera 1118 may be a security camera which may record an area surrounding electronic gate lock device 1100. Camera with keypad 1185 may be disposed on a house or building (e.g., the front side of a house or building) which is part of an enclosure on which electronic gate lock device 1100 is disposed. Camera with keypad 1185 may be used to alert a user of a potential entrant's presence while the potential entrant is out of the line-of-sight of cameras included in electronic gate lock device 1100, such that the user may switch pawl 1104 to the unlocked state if the potential entrant's identity is verified. Camera with keypad 1185 may be configured to accept a wireless authentication, a biometric reading, or any other type of authentication used to verify the identity of a potential entrant. Siren 1187 may be used to sound an alarm in response to a panic or alarm signal activated by computing device 1108.

Wireless communication device 1112 may communicate with plural external input devices through various wireless communication protocols. For example, wireless communication device 1012 may communicate with plural external input devices by one or more of Bluetooth, near-field communication (NFC), WiFi, radio-frequency identification (RFID), radio-frequency (RF), infrared radiation (IR), Z-Wave, ZigBee, 6LoWPAN, Thread, Long-Term Evolution (LTE), or other wireless communication protocol.

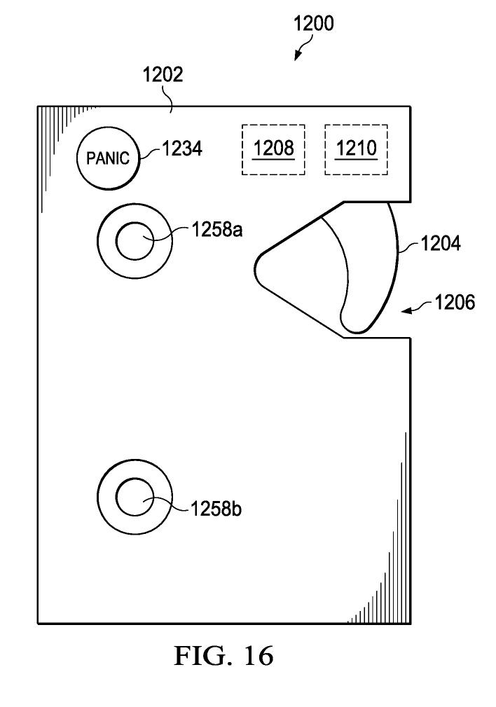

FIG. 16 is a side elevation view of electronic gate lock device 1200 having wired input device 1225 connected thereto in accordance with a representative embodiment. Electronic gate lock device 1200 includes body 1202, which includes opening 1206, bolt holes 1258a, 1258b for mounting or attaching electronic gate lock device 1200 to an enclosure or a movable barrier, and pawl 1204 disposed in opening 1206. Pawl 1204 is pivotally connected to body 1202. Electronic gate lock device 1200 further includes motor 1210, which is configured to switch pawl 1204 between a locked state and an unlocked state, and computing device 1208, which is configured to control motor 1210. Electronic gate lock device 1200 further includes panic button 1234 disposed on an outside surface of body 1202. Panic button 1234 sends electronic gate lock device 1200 into an alarmed state when pressed by a user. The alarmed state may also be activated by a predetermined verbal command communicated to computing device 1108 through a microphone or other connected audio capture device. In the alarmed state, pawl 1204 is switched to the locked state. Computing device 1208 may be configured, e.g., to actuate lights on electronic gate lock device 1200 to flash on and off. Computing device 1208 may further control a speaker to sound an alarm. Computing device 1208 may also silently signal a wired or wireless communication device to alert service authorities (e.g., police, security personnel, or the like). Electronic gate lock device 1200 may regularly ping a plurality of network devices connected wirelessly to electronic gate lock device 1200. The alarmed state may be activated by a loss of signal during regularly transmitted pinging, or if the electronic gate lock device detects a loss of power. When the alarmed state is activated in electronic gate lock device 1200, the plurality of network devices connected to the electronic gate lock device may also enter an alarmed state.

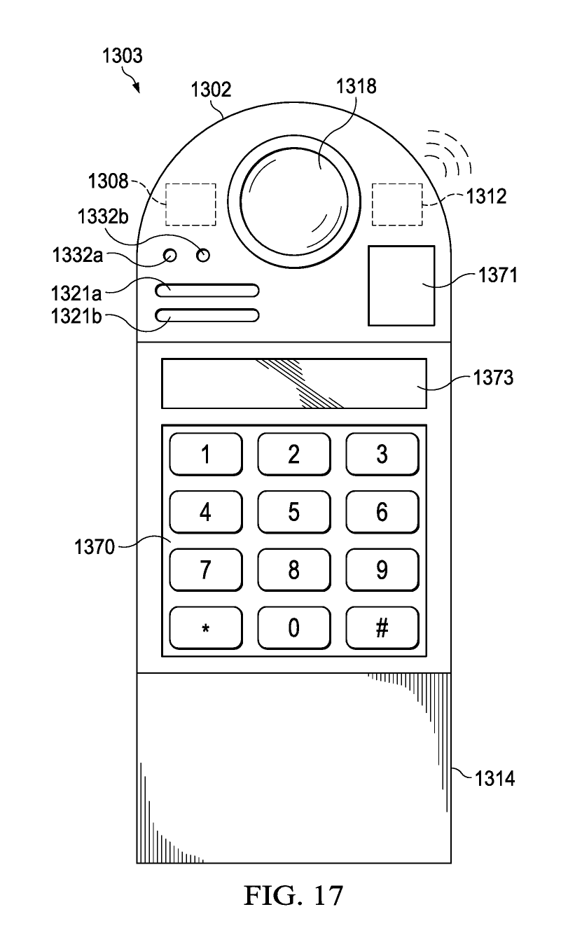

FIG. 17 is a front elevation view of external authentication device 1303 in accordance with a representative embodiment. External authentication device 1303 may include body 1302, computing device 1308, wireless communication device 1312, battery 1314, camera 1318, a plurality of openings 1321a, 1321b, indicator lights 1332a, 1332b, keypad 1370, biometric authentication device 1371, and screen 1373. Computing device 1308 may communicate with or otherwise control other electronic components of external authentication device 1303, including, e.g., wireless communication device 1312, camera 1318, indicator lights 1332a, 1332b, keypad 1370, biometric authentication device 1371, screen 1373, a microphone disposed within body 1302, a speaker disposed within body 1302, or any other devices included in external authentication device 1303. Wireless communication device 1312 may allow computing device 1308 to communicate wirelessly with a plurality of external devices. For example, wireless communication device 1312 may allow computing device 1308 to communicate wirelessly with an electronic gate lock device provided according to any of the above-described embodiments.

Battery 1314 may provide power to computing device 1308, wireless communication device 1312, camera 1318, indicator lights 1332a, 1332b, keypad 1370, biometric authentication device 1371, screen 1373, a microphone disposed within body 1302, a speaker disposed within body 1302, or any other devices included in external authentication device 1303. Battery 1314 may be disposed externally to body 1302, as representatively illustrate in FIG. 17, or battery 1314 may be disposed within body 1302. Battery 1314 may be rechargeable or replaceable. The plurality of openings 1321a, 1321b may allow a speaker, a microphone, a camera, or another device disposed within body 1302 of external authentication device 1303 to interact with an area surrounding external authentication device 1303. Camera 1318 may be used to record an area surrounding external authentication device 1303. Indicator lights 1332a, 1332b may be used to indicate an operating condition of external authentication device 1303. For example, computing device 1308 may turn on indicator lights 1332a, 1332b to indicate that battery 1314 is low, to indicate whether external authentication device 1303 is connected to other devices, or to otherwise indicate a status of external authentication device 1303. Indicator lights 1332a, 1332b may comprise light emitting diodes (LEDs), incandescent bulbs, fluorescent bulbs, high-intensity discharge (HID) bulbs, or any other type of light source. Screen 1373 may be configured to display visual information, such as status of external authentication device 1303, or the like. Screen 1373 may include touch screen controls, and may be used to control computing device 1308.

Keypad 1370 may be connected to computing device 1308. Computing device 1308 may be configured to send a signal to an electronic gate lock device provided according to any of the above-described embodiments through wireless communication device 1312 in response to a signal from keypad 1370. For example, computing device 1308 may send a signal to the electronic gate lock device instructing the electronic gate lock device to be locked or unlocked based on a key sequence entered with keypad 1370. Biometric authentication device 1371 may be connected to computing device 1308. Computing device 1308 may be configured to send a signal to the electronic gate lock device in response to a signal from biometric authentication device 1371. For example, biometric authentication device 1371 may authenticate an identity of a potential entrant based on a fingerprint, a retina scan, iris recognition, finger vein identification, facial recognition, voice recognition, or any other biometric data. Computing device 1308 may send a signal to the electronic gate lock device instructing the electronic gate lock device to be locked or unlocked based on the authenticated identification of the potential entrant obtained by biometric authentication device 1371.

External authentication device 1303 may be attached to an enclosure (e.g., a fence, a wall, or the like), a stationary structure (e.g., a post, a doorway, or the like), or a movable barrier (e.g., a gate, a door, or the like). For example, in at least one embodiment, external authentication device 1303 may be attached to an enclosure. External authentication device 1303 may be attached to the enclosure by screws, nails, bolts, a mounting plate, welding, combinations thereof, or the like.

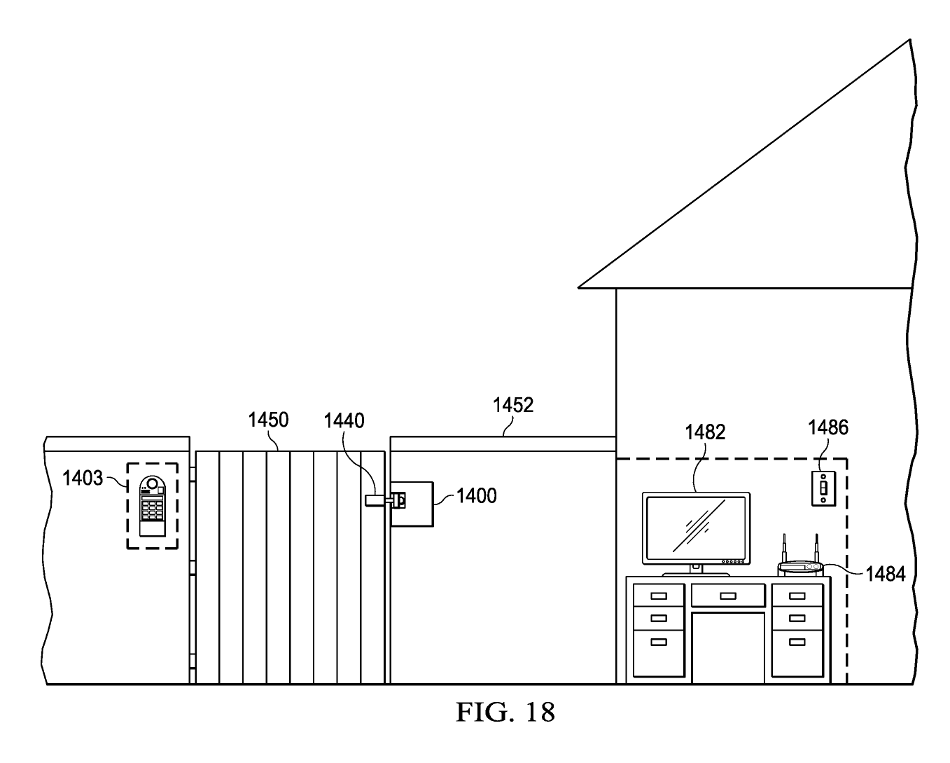

FIG. 18 is a front elevation view of a system in which electronic gate lock device 1400 is mounted on enclosure 1452, latch bar 1440 is mounted on movable barrier 1450, and external authentication device 1403 is mounted on enclosure 1452, in accordance with an embodiment. In representative aspects, electronic gate lock device 1400 may be a device according to any of the above-described embodiments, latch bar 1440 may be a latch bar according to any above-described embodiment, and external authentication device 1403 may be an external authentication device according to any above-described embodiment. The system may further include computer 1482, router 1484, and wall-mounted switch 1486.

Electronic gate lock 1400 may secure latch bar 1440 in any position along latch bar 1440. For example, electronic gate lock 1400 may secure latch bar 1440 by a distal portion of latch bar 144o, a central portion of latch bar 144o, or any other portion of latch bar 1440. Latch bar 1440 may be of a traditional size and shape, or may be a proprietary design. Electronic gate lock 1400 and latch bar 1440 may be complementary and electronic gate lock 1400 may be designed to operate with a specific design of latch bar 1440.

Movable barrier 1450 may be in an open position or a closed position. Latch bar 1440 is disposed in an opening of electronic gate lock device 1400 when movable barrier 1450 is in the closed position, and latch bar 1440 is disposed outside of the opening of electronic gate lock device 1400 when movable barrier 1450 is in the open position. Electronic gate lock device 1400 is configured to have a locked state and an unlocked state. When electronic gate lock device 1400 is in the unlocked state, movable barrier 1450 can be moved between open and closed positions. However, when electronic gate lock device 1400 is in the locked state, movable barrier 1450 can be moved from the open position to the closed position, but not from the closed position to the open position. Accordingly, movable barrier 1450, latch bar 1440, enclosure 1452, and electronic gate lock device 1400 are configured to control access to a secured area disposed on one side of movable barrier 1450 and enclosure 1452.

External authentication device 1403 and wall-mounted switch 1486 may be configured to communicate with electronic gate lock device 1400 through at least one of a wired or a wireless connection. External authentication device 1403 may be used, e.g., to authenticate credentials of a potential entrant, and signal electronic gate lock device 1400 to switch between the locked state and the unlocked state once a potential entrant has been authenticated. Wall-mounted switch 1486 may be located in a secure location, and may be configured to switch electronic gate lock device 1400 between the locked state and the unlocked state without requiring authentication.

Computer 1482 may be configured to communicate wirelessly with electronic gate lock device 1400 through router 1484. In a representative aspect, a user may use computer 1482 to control electronic gate lock device 1400, and switch electronic gate lock device 1400 between the locked state and the unlocked state. External input devices may connect to router 1484 in order to wirelessly communicate with electronic gate lock device 1400. Router 1484 may comprise a wireless router, a smart hub, a network hub, any other networking device, combinations thereof, or the like. A plurality of external devices may further be included in the system and may be configured to control electronic gate lock device 1400, change various parameters of electronic gate lock device 1400, supply updates to electronic gate lock device, or the like.

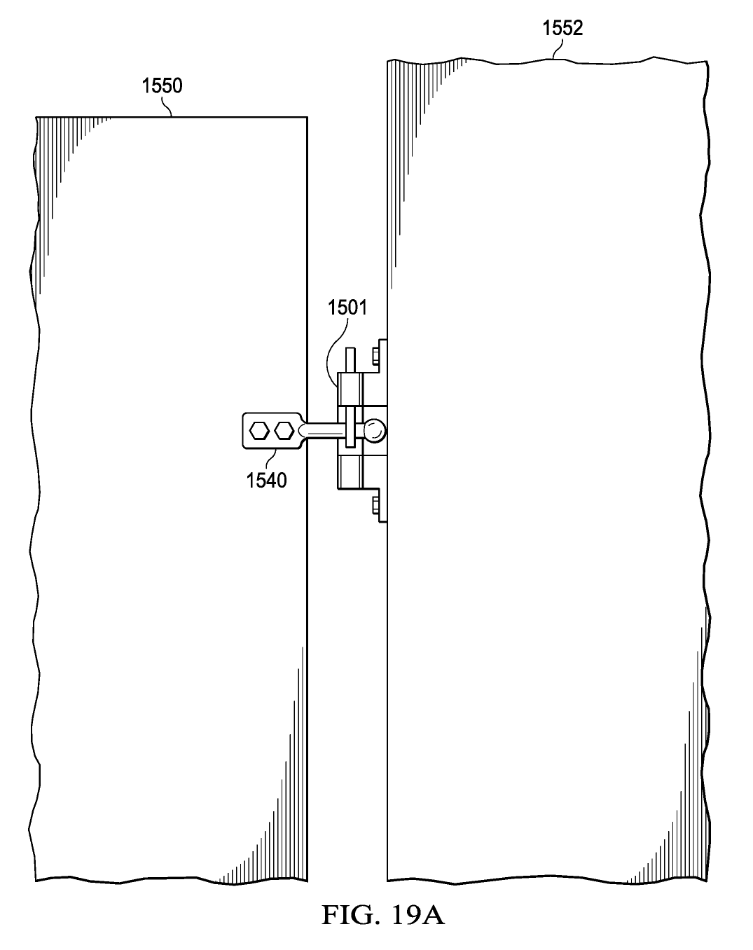

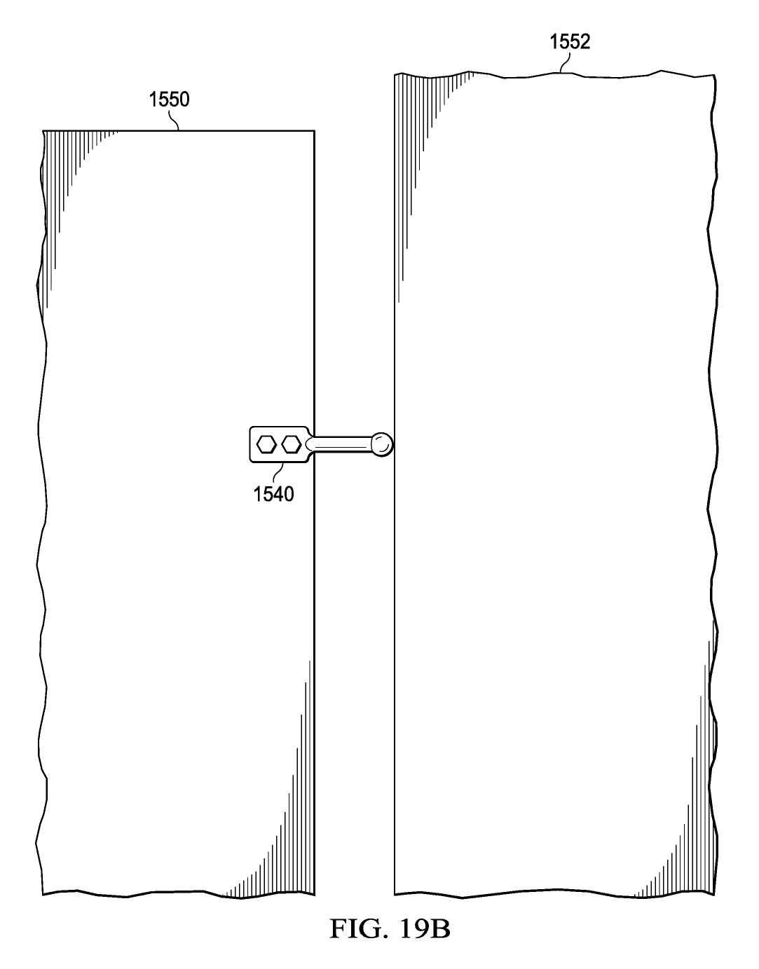

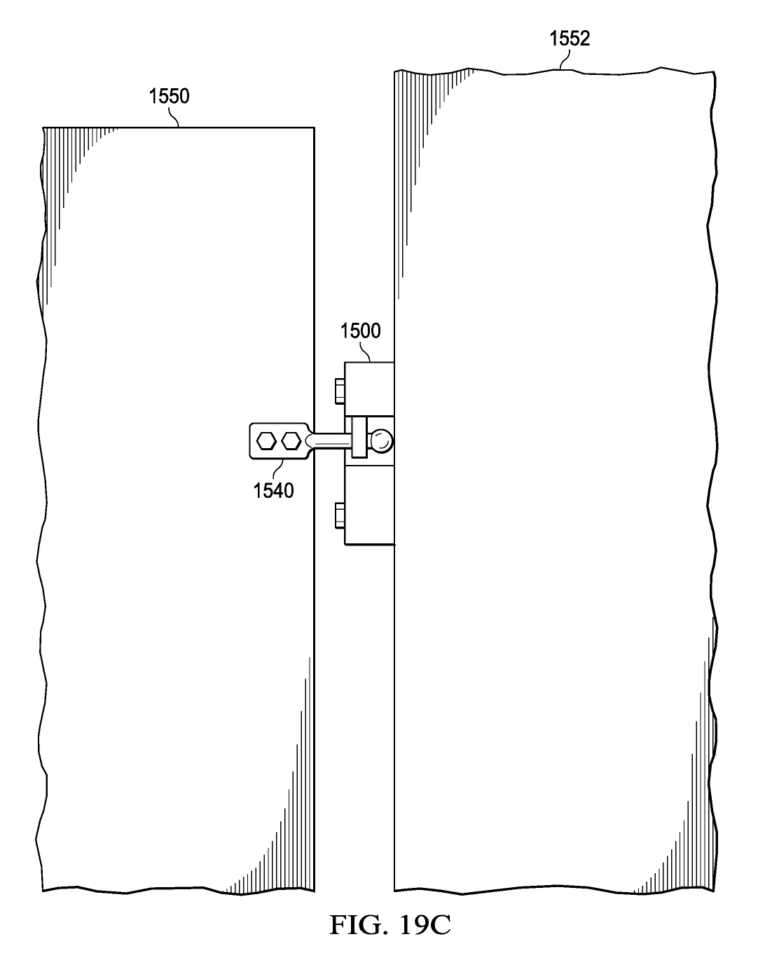

FIGS. 19A-19C illustrate front elevation views of a method of replacing conventional gate latch apparatus 1501 with electronic gate lock device 1500 according to any of the previously-described embodiments, in accordance with an embodiment. As representatively illustrated in FIG. 19A, latch bar 1540 may be attached to or mounted on movable barrier 1550. Conventional gate latch apparatus 1501 may be attached to or mounted on enclosure 1552. As representatively illustrated in FIG. 19B, conventional gate latch apparatus 1501 may be removed from enclosure 1552, and latch bar 1540 may remain attached to movable barrier 1550. As representatively illustrated in FIG. 15C, electronic gate lock device 1500 may be attached to or mounted on enclosure 1552. Electronic gate lock device 1500 may include an opening and a pawl. Electronic gate lock device 1500 is configured to receive latch bar 1540 in the opening, and the pawl is configured to retain latch bar 1540.

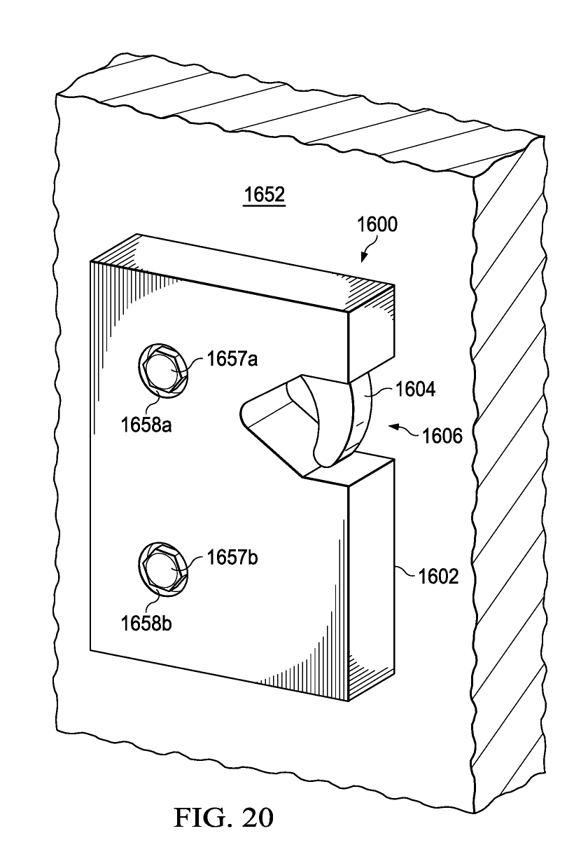

FIG. 20 is a perspective view of electronic gate lock device 1600 attached to enclosure 1652 in accordance with a representative embodiment. Electronic gate lock device 1600 includes body 1602, pawl 1604, opening 1606, and bolt holes 1658a, 1658b. In this embodiment, electronic gate lock device 1600 is attached to enclosure 1652 by bolts 1657a, 1657b disposed in bolt holes 1658a, 1658b and driven into holes formed in enclosure 1652. Although the embodiment representatively illustrated in FIG. 16 depicts two bolts 1657a, 1657b formed in two bolt holes 1658a, 1658b, any number of bolts 1657 may be disposed in any number of bolt holes 1658. For example, 3, 4, 5, 6, or any number of bolt holes 1658 may be formed in body 1602 of electronic gate lock device 1600 and bolts 1657 may be disposed in each of bolt holes 1658.

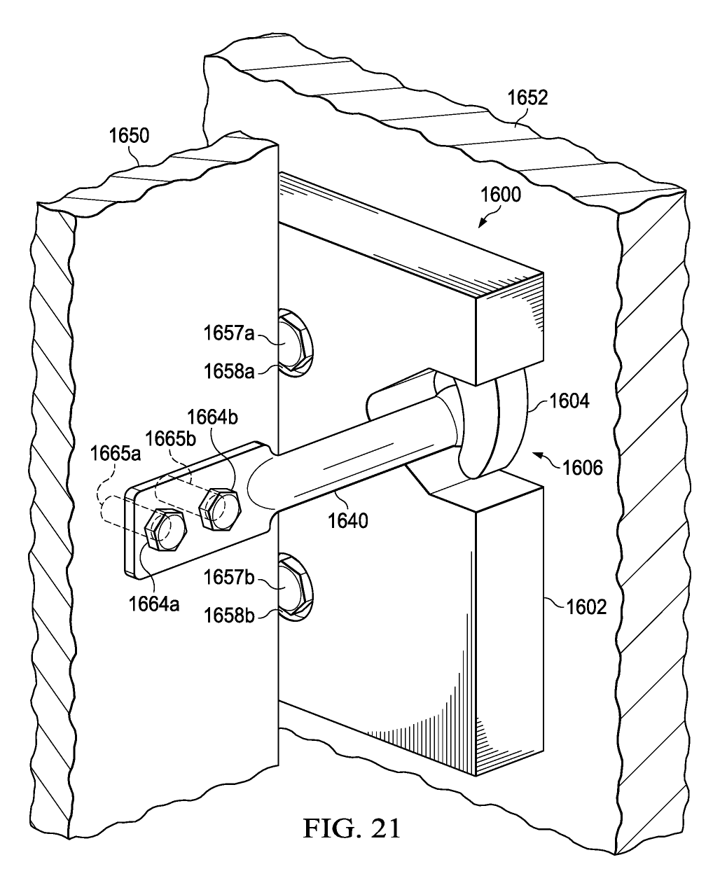

FIG. 21 is a perspective view of latch bar 1640 attached to movable barrier 165o and electronic gate lock device 1600 attached to enclosure 1652, in accordance with a representative embodiment. Latch bar 1640 may comprise screw holes 1665a, 1665b. Screws 1664a, 1664b may be disposed in screw holes 1665a, 1665b, and may be used to attach latch bar 1650 to movable barrier 1650. For example, screws 1664a, 1664b may be driven through screw holes 1665a, 1665b and into movable barrier 1650 in order to attach latch bar 1640 to movable barrier 1650. Movable barrier 1650 may be in a closed position or an open position relative to enclosure 1652. In the open position, latch bar 1640 may be disposed outside of opening 1606, while in the closed position, latch bar 1640 may be disposed within opening 1606. As representatively illustrated in FIG. 21, latch bar 1640 may be secured by pawl 1604 when latch bar 1640 is disposed within opening 1606.

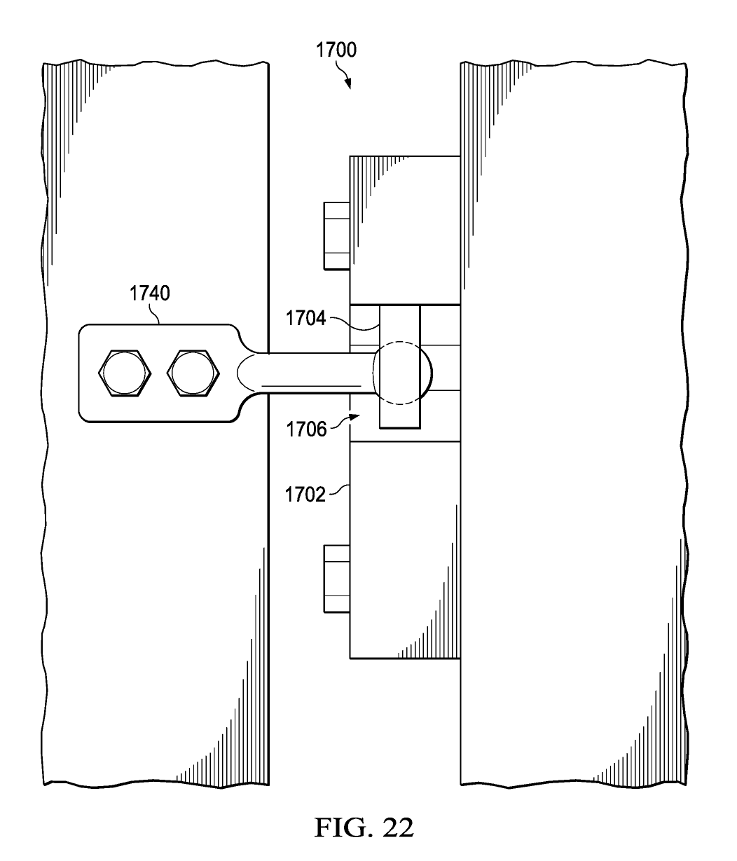

FIG. 22 is a front elevation view of electronic gate lock device 1700 and latch bar 1740, in accordance with a representative embodiment. Electronic gate lock device 1700 includes body 1702, pawl 1704, and opening 1706. Electronic gate lock device 1700 may be configured to accept latch bars 1740 having a variety of sizes and shapes. Moreover, electronic gate lock device 1700 may be configured to accept any part or portion of latch bar 1740. For example, as representatively illustrated in FIG. 22, electronic gate lock device 1700 may be configured to accept a distal portion of latch bar 1740 within opening 1706 and secure the distal portion of latch bar 1740 with pawl 1704. Electronic gate lock device 1700 may be configured to receive other portions or parts of latch bar 1740, such as, e.g., a central portion, or a proximal portion.

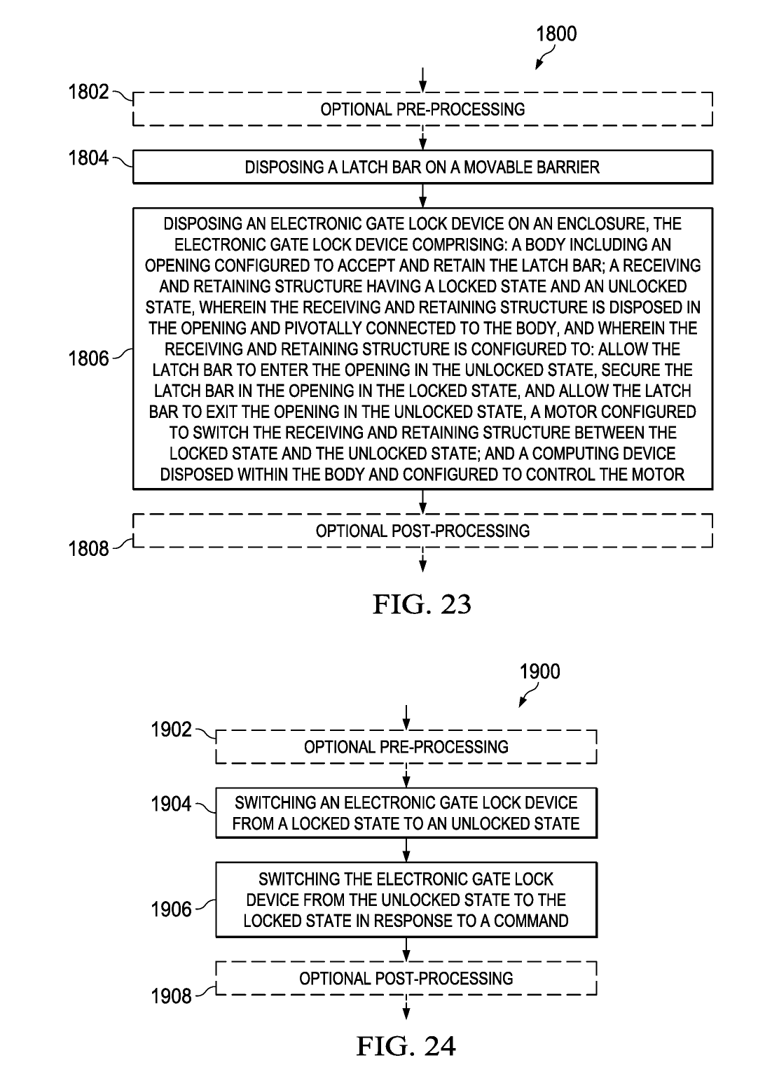

FIG. 23 illustrates a flow diagram of a method 1800 in accordance with a representative embodiment. In step 1802, various optional pre-processing steps may be engaged (e.g., site or equipment inspections, or other preparations preliminary to installation of an electronic gate lock device in accordance with representative aspects). In step 1804, a latch bar is disposed on a movable barrier. In step 1806, an electronic gate lock device is disposed on an enclosure, where the electronic gate lock device comprises a body (including an opening disposed therein, where the opening is configured to accept and retain the latch bar), a pawl having a locked state and an unlocked state (wherein the pawl is disposed in the opening and is pivotally connected to the body, and is configured to allow the latch bar to enter the opening in the unlocked state, secure the latch bar in the opening in the locked state, and allow the latch bar to exit the opening in the locked state), a motor configured to switch the pawl between the locked state and the unlocked state, and a computing device disposed within the body (where the computing device is configured to control the motor). In step 1808, various optional post-processing steps may be engaged (e.g., post-installation testing, inspections, or the like).

FIG. 24 illustrates a flow diagram of a method 1900 in accordance with a representative embodiment. In step 1902, various optional pre-processing steps may be engaged (e.g., mounting a latch bar to a movable barrier, mounting an electronic gate lock device to an enclosure, programming the electronic gate lock device, connecting the electronic gate lock device to a plurality of external input devices, or other preparations preliminary to operation of an electronic gate lock device in accordance with representative aspects). In step 1904, the electronic gate lock device is switched from a locked state to an unlocked state. The electronic gate lock device may include a body, a pawl, an opening, a computing device, and a motor. The pawl may be pivotally attached to the body in the opening. The pawl may have a locked state and an unlocked state. The electronic gate lock device may be configured such that the latch bar may enter or exit the opening when the pawl is in the unlocked state. The electronic gate lock device may further be configured such that the latch bar may enter the opening, but not exit the opening when the pawl is in the locked state. Accordingly, the electronic gate lock device and the latch bar may restrict access to a secured area on one side of the enclosure and the movable barrier. The motor may be configured to switch the pawl between the locked state and the unlocked state in response to a signal sent from the computing device. In step 1906, the electronic gate lock device may be switched from the unlocked state back to the locked state in response to a command. The computing device may issue the command after a predetermined time, a predetermined number of openings and closings of the movable barrier, once the latch bar is detected in the opening, once the gate has been closed, once a button on the electronic gate lock device has been pressed, or the like. In step 1908, various optional post-processing steps may be engaged (e.g., electronic gate lock device testing, inspections, parts of the electronic gate lock device may be upgraded or updated, firmware or software may be updated, parameters stored in the electronic gate lock device may be altered, wireless or wired external input devices may be added to or removed from the electronic gate lock device's network, or the like).

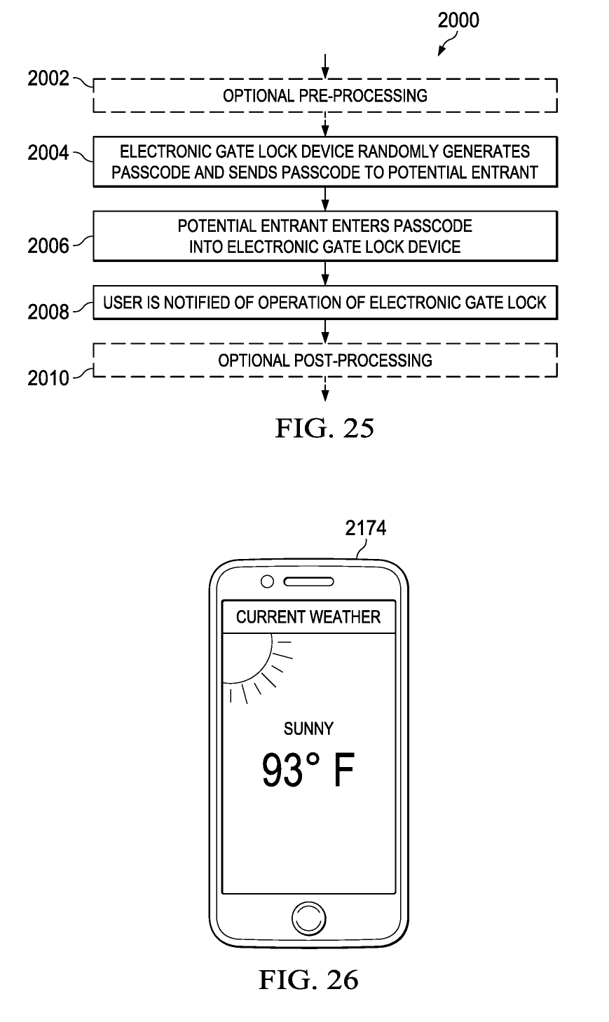

FIG. 25 illustrates a flow diagram of a method 2000 in accordance with a representative embodiment. In step 2002, various pre-processing steps may be engaged (e.g., performance of a service may be ordered, a product may be ordered, an order may be processed, a delivery may be set up, a customer may be notified of an upcoming delivery, an appointment may be made, an order may be mailed or other preparations preliminary to use of an electronic gate lock device in accordance with representative aspects). In step 2004, an electronic gate lock device, such as an electronic gate lock device according to any of the previously-described embodiments, may generate a passcode. The electronic gate lock device may be attached to an enclosure, a latch bar may be attached to a movable barrier, and the electronic gate lock device coupled with the latch bar may restrict access to a secured area. The passcode may be randomly generated, generated by a user or property owners, or the like. The passcode may be sent to a potential entrant. The potential entrant may be a service provider, a deliveryman, an associate, or any other person the user wishes to grant access to a secured area. When the potential entrant arrives at the location of the electronic gate lock device, the electronic gate lock device may detect the presence of the potential entrant by way of a microphone, a camera, a motion detector, or another detection device included in the electronic gate lock device. In step 2006, the potential entrant enters the passcode into the electronic gate lock device. The potential entrant may enter the passcode into a keypad provided on the electronic gate lock device, a keypad provided in wireless or wired communication with the electronic gate lock device, an application installed on the potential entrant's phone, tablet, laptop, or computer, or the like. The potential entrant may also verbally provide the passcode to a speaker included in the electronic gate lock device. The potential entrant may be recorded by a camera, a speaker, other recording devices, or the like included in the electronic gate lock device. A microphone, a screen, or the like provided in the electronic gate lock device may relay instructions to the potential entrant. The electronic gate lock device may detect various hazards to the potential entrant, such as dogs barking, and instruct the potential entrant to return at another time. The electronic gate lock device may produce an audible chime or buzz while the movable barrier is open. The audible chime or buzz may urge the potential entrant to shut the movable barrier after they have opened it. In step 2008, the user may be notified of the operation of the electronic gate lock. For instance, the user may be notified once the movable barrier has been opened and closed. The potential entrant may also be able to confirm their use of the electronic gate lock via a keypad, a touch screen, a button, an audible message, or the like. In step 2010, various post-processing steps may be engaged (e.g., follow-up appointments may be ordered, repeat appointments may be made, or the like).

FIG. 26 is a front elevation view of cell phone 2174 in accordance with a representative embodiment. Cell phone 2174 may be connected to an electronic gate lock device, such as an electronic gate lock device according to any of the previously-described embodiments, through a wireless or a wired connection. The electronic gate lock device may include a weather monitoring device. The weather monitoring device may include a plurality of sensors, such as a temperature sensor, a motion sensor, a humidity sensor, a light sensor, a seismic sensor, a vibration sensor, an air quality monitor, or the like. As representatively illustrated in FIG. 26, cell phone 2174 may include an application having a graphical user interface (GUI), which displays weather data obtained from the weather monitoring device of the electronic gate lock device.

Specific benefits and advantages of representative embodiments include the ability to lock a movable barrier disposed in an opening of an enclosure in order to restrict access to a secured area without the need for keys. An electronic gate lock device according to some embodiments may be switched between a locked state and an unlocked state with keys or various input devices. Representative electronic gate lock devices may be used to allow a property owner to lock and unlock a movable barrier from a remote location, or on a temporary basis. For example, according to various embodiments, a property owner may grant a person a temporary password, or the property owner may remotely unlock the electronic gate lock device. Entry into the secured area may also be provided on certain dates, at specific times, or for a specified number of times before the pawl is switched to the locked state and the electronic gate lock device is locked.

In a representative embodiment, a device includes a body having an opening configured to accept a latch bar and a pawl having a locked state and an unlocked state. The pawl is disposed in the opening and pivotally connected to the body. The device further includes a motor configured to switch the pawl between the locked state and the unlocked state. The device includes a computing device configured to control the motor. The pawl may be configured to allow the latch bar to enter the opening in the unlocked state or the locked state, allow the latch bar to exit the opening in the unlocked state, and trap the latch bar in the opening in the locked state. The device may further include a wireless communication device configured to provide wireless communication between the computing device and an external input device. The wireless communication device may be configured to wirelessly communicate by one or more of Bluetooth, near-field communication (NFC), WiFi, radio-frequency identification (RFID), radio-frequency (RF), infrared radiation (IR), Z-Wave, ZigBee, 6LoWPAN, Thread, Long-Term Evolution (LTE), or other wireless communication protocol. The external input device may be at least one of a cell phone, a tablet, a computer, a key fob, a router, a radio-frequency identification (RFID) card, an RFID token, an external authentication device, or a remote control. The device may further include a wired communication port configured to provide wired communication between the computing device and an input device. The input device may be at least one of a weather monitoring device, a cell phone, a tablet, a computer, a keypad, an external authentication device, or a biometric authentication device. The body may be configured to be weather resistant, shock resistant, and tamper-proof. The device may further include at least one of a weather monitoring device, a speaker, a microphone, or a camera disposed within the body. The device may further include a power source configured to provide power to the motor and the computing device. The power source may include at least one of a battery (e.g., internal, or external), a wired power source, or a power generation device. The device may further include a panic button disposed on an outside surface of the body. The panic button may be configured to place the computing device in an alarmed state. In the alarmed state, the computing device may be configured to activate a speaker to sound an alarm, and control the motor to switch the pawl to the locked state. The device may further include a manual actuator configured to override computing device control of the motor.

In another representative embodiment, a system for locking a movable barrier in a closed position relative to an enclosure includes a latch bar attached to a movable barrier and a device attached to an enclosure. The movable barrier is rotatable between an open position and a closed position. The device includes a body having an opening configured to accept and retain the latch bar and a pawl having a locked state and an unlocked state. The pawl is disposed in the opening and pivotally connected to the body. The pawl is configured to allow the latch bar to enter the opening in the unlocked state or the locked state, fasten the latch bar in the opening in the locked state, and allow the latch bar to exit the opening in the unlocked state. The device further includes a motor configured to switch the pawl between the locked state and the unlocked state and a computing device disposed within the body. The computing device is configured to control the motor. The latch bar may be configured to be removable from the movable barrier, and the device may be configured to be removable from the enclosure when the pawl is in the unlocked state. The latch bar may be configured to be substantially irremovable from (e.g., affixed to) the movable barrier, and the device may be configured to be substantially irremovable from (e.g., affixed to) the enclosure when the pawl is in the locked state. The latch bar may be attached to the movable barrier through a latch bar mounting plate, and the device may be attached to the enclosure through a device mounting plate. In representative embodiments, the pawl may be configured to pivot between an extended position and a retracted position in the unlocked state, pivot between the extended position and the retracted position when the movable barrier is rotated from the open position to the closed position in the locked state, or remain fixed in the extended position in the locked state when the movable barrier is in the closed position. The device may further include a detector configured to detect whether the latch bar is disposed in the opening. The detector may be further configured to communicate with the computing device. The device may further include an internal locking device configured to substantially irremovably affix the device to a device mounting plate when the internal lock is in a fastened state.

In yet another representative embodiment, a method includes disposing a latch bar on a movable barrier and disposing a device on an enclosure. The device includes a body having an opening configured to accept and retain the latch bar and a pawl having a locked state and an unlocked state. The pawl is disposed in the opening and pivotally connected to the body. The pawl is configured to allow the latch bar to enter the opening in the unlocked state or the locked state, secure the latch bar in the opening in the locked state, and allow the latch bar to exit the opening in the unlocked state. The device further includes a motor configured to switch the pawl between the locked state and the unlocked state, and a computing device disposed within the body. The computing device is configured to control the motor.

In still another representative embodiment, a device includes a body including: an opening configured to accept an engaging structure, and a retaining structure operable for disposition in a locked configuration and an unlocked configuration, the locked configuration different than the unlocked configuration, wherein the retaining structure is disposed adjacent the opening. The device further includes a motor configured to switch the retaining structure between the locked configuration and the unlocked configuration. The device further includes a computing device configured to control the motor.

As used herein, the terms “comprises,” “comprising,” “includes,” “including,” “has,” “having,” or any contextual variant thereof, are intended to reference a non-exclusive inclusion. For example, a process, product, article, or apparatus that comprises a list of elements is not necessarily limited to only those elements, but may include other elements not expressly listed or inherent to such process, product, article, or apparatus. Furthermore, unless expressly stated to the contrary, “or” refers to an inclusive or and not an exclusive or. That is, the term “or” as used herein is generally intended to mean “and/or” unless otherwise indicated. For example, a condition “A or B” is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural connotations for such term, unless the context clearly indicates otherwise.

Although steps or operations may be presented in a specific order, this order may be changed in different embodiments. In some embodiments, to the extent multiple steps are shown as sequential in the preceding description, some combination of such steps in alternative embodiments may be performed at a same time. The sequence of operations described herein may be interrupted, suspended, or otherwise controlled by another process.

It will also be appreciated that one or more elements illustrated in the Figures may also be implemented in a more-separated or more-integrated manner, or even removed or rendered inoperable in certain cases, as may be useful in accordance with particular applications and embodiments. Additionally, any lines or arrows in the Figures should be considered only as representative, and therefore not limiting, unless otherwise specifically noted.

Examples or illustrations provided herein are not to be regarded in any way as restrictions on, limits to, or express definitions of any term or terms with which they are associated. Instead, these examples or illustrations are to be regarded as being described with respect to a particular embodiment and as merely illustrative. Those skilled in the art will appreciate that any term or terms with which these examples or illustrations are associated will encompass other embodiments that may or may not be given therewith or elsewhere in the specification, and all such embodiments are intended to be included within the scope of that term or set of terms. Language designating such non-limiting examples and illustrations includes, but is not limited to: “for example,” “for instance,” “e.g.,” “etc., “or the like,” “in a representative embodiment,” “in one embodiment,” “in another embodiment,” “in some embodiments,” or the like. Reference throughout this specification to “one embodiment,” “an embodiment,” “a representative embodiment,” “a particular embodiment,” or “a specific embodiment,” or contextually similar terminology, generally means that a particular feature, structure, property, or characteristic described in connection with the described embodiment is included in at least one embodiment, but may not necessarily be present in all embodiments. Thus, respective appearances of the phrases “in one embodiment,” “in an embodiment,” or “in a specific embodiment,” or similar terminology in various places throughout the description are not necessarily referring to the same embodiment. Furthermore, particular features, structures, properties, or characteristics of any specific embodiment may be combined in any suitable manner with one or more other embodiments.

The scope of the present disclosure is not intended to be limited to particular embodiments of any process, product, machine, article of manufacture, assembly, apparatus, means, methods, or steps herein described. As one skilled in the art will appreciate, various processes, products, machines, articles of manufacture, assemblies, apparatuses, means, methods, or steps, whether presently existing or later developed, that perform substantially the same function or achieve substantially similar results in correspondence to embodiments described herein, may be utilized according to their description herein. The appended claims are intended to include within their scope such processes, products, machines, articles of manufacture, assemblies, apparatuses, means, methods, or steps.

Benefits, advantages, and solutions to problems have been described herein with regard to representative embodiments. However, any benefits, advantages, solutions to problems, or any component thereof that may cause any benefit, advantage, or solution to occur or to become more pronounced are not to be construed as critical, required, or essential features or components.

What is claimed is:

1. A device comprising:
a body having an opening configured to accept a latch bar;
a pawl having a locked state and an unlocked state, wherein the pawl is disposed in the opening and pivotally connected to the body;
a motor configured to switch the pawl between the locked state and the unlocked state; and
a computing device configured to control the motor.

2. The device of claim 1, wherein at least one of:
the latch bar is configured to enter or exit the opening in a direction substantially perpendicular to a major surface of the body;
the locked state comprises a gate being in the locked state; or
the unlocked state comprises the gate being in the unlocked state.

3. The device of claim 2, wherein the pawl is configured to allow the latch bar to enter the opening in the unlocked state or the locked state, allow the latch bar to exit the opening in the unlocked state, and trap the latch bar in the opening in the locked state.

4. The device of claim 3, further comprising a wireless communication device configured to provide wireless communication between the computing device and an external input device.

5. The device of claim 4, wherein the wireless communication device is configured to wirelessly communicate by one or more of Bluetooth, near-field communication (NFC), WiFi, radio-frequency identification (RFID), radio-frequency (RF), infrared radiation (IR), Z-Wave, ZigBee, 6LoWPAN, Thread, Long-Term Evolution (LTE), or other wireless communication protocol.

6. The device of claim 5, wherein the external input device is at least one of a cell phone, a tablet, a computer, a key fob, a router, a radio-frequency identification (RFID) card, an RFID token, an external authentication device, or a remote.

7. The device of claim 2, further comprising a wired communication port configured to provide wired communication between the computing device and an input device.

8. The device of claim 7, wherein the input device is at least one of a weather monitoring device, a cell phone, a tablet, a computer, a keypad, an external authentication device or a biometric authentication device.

9. The device of claim 2, wherein the body is configured to be weather resistant, shock resistant, and tamper-proof.

10. The device of claim 9, further comprising at least one of a weather monitoring device, a speaker, a microphone, or a camera disposed within the body.

11. The device of claim 10, further comprising a power source configured to provide power to the motor and the computing device, wherein the power source comprises at least one of a battery, a wired power source, or a power generation device.

12. The device of claim 11, further comprising a panic button disposed on an outside surface of the body, the panic button configured to place the computing device in an alarmed state, wherein in the alarmed state, the computing device activates a speaker to sound an alarm and controls the motor to switch the pawl to the locked state.

13. The device of claim 1, further comprising a manual actuator configured to override computing device control of the motor.

14. A system for locking a movable barrier in a closed position relative to an enclosure, the system comprising:
a device attached to an enclosure, the device comprising:
a body having an opening configured to accept and retain a latch bar, the latch bar attached to a movable barrier, the movable barrier being rotatable between an open position and a closed position relative to the enclosure;
a pawl having a locked state and an unlocked state, wherein the pawl is disposed in the opening and pivotally connected to the body, and wherein the pawl is configured to:
allow the latch bar to enter the opening in the unlocked state or the locked state;
fasten the latch bar in the opening in the locked state; and
allow the latch bar to exit the opening in the unlocked state;
a motor configured to switch the pawl between the locked state and the unlocked state; and
a computing device disposed within the body, the computing device configured to control the motor.

15. The system of claim 14, wherein the latch bar is configured to move in a direction substantially normal to a major surface of the body when the movable barrier is rotated between the open position and the closed position.

16. The system of claim 15, wherein the latch bar is configured to be removable from the movable barrier, and the device is configured to be removable from the enclosure when the pawl is in the unlocked state.

17. The system of claim 16, wherein the latch bar is configured to be irremovable from the movable barrier and the device is configured to be irremovable from the enclosure when the pawl is in the locked state.

18. The system of claim 17, wherein the latch bar is attached to the movable barrier through a latch bar mounting plate and the device is attached to the enclosure through a device mounting plate.

19. The system of claim 18, wherein the pawl is configured to pivot between an extended position and a retracted position in the unlocked state, pivot between the extended position and the retracted position when the movable barrier is rotated from the open position to the closed position in the locked state, and remain fixed in the extended position in the locked state when the movable barrier is in the closed position.

20. The system of claim 19, wherein the device further comprises a detector configured to detect whether the latch bar is disposed in the opening, and communicate with the computing device.

21. The system of claim 20, wherein the device further comprises an internal locking device configured to substantially irremovably affix the device to a device mounting plate when the internal locking device is in a fastened state.

22. A method comprising:
disposing a latch bar on a movable barrier; and
disposing a device on an enclosure, the device comprising:
a body having an opening configured to accept and retain the latch bar;
a pawl having a locked state and an unlocked state, wherein the pawl is disposed in the opening and pivotally connected to the body, and wherein the pawl is configured to:
allow the latch bar to enter the opening in the unlocked state or the locked state;
secure the latch bar in the opening in the locked state; and
allow the latch bar to exit the opening in the unlocked state;
a motor configured to switch the pawl between the locked state and the unlocked state; and
a computing device disposed within the body, the computing device configured to control the motor.

23. The method of claim 22, wherein the movable barrier is rotated about a pivot between an open position and a closed position relative to the enclosure, the latch bar being disposed in the opening when the movable barrier is in the closed position, the latch bar being disposed outside of the opening when the movable barrier is in the open position, and wherein the latch bar moves in a direction substantially normal to a major surface of the body when the movable barrier is rotated between the open position and the closed position.

24. A device comprising:
a body comprising:
an opening configured to accept an engaging structure; and
a retaining structure operable for disposition in a locked configuration and an unlocked configuration, the locked configuration different than the unlocked configuration, wherein the retaining structure is disposed adjacent the opening;
a motor configured to switch the retaining structure between the locked configuration and the unlocked configuration; and
a computing device configured to control the motor.

25. The device of claim 24, wherein the opening is configured to accept the engaging structure when the engaging structure is moved in a direction substantially perpendicular to a major surface of the body.
